(19) United States
(12) Patent Application Publication
(10) Pub. No.: US 2002/0127144 A1
(43) Pub. Date: Sep. 12, 2002

(54) Device for analyzing particles and method of use

(76) Inventor: Shailesh P. Mehta, Gainesville, FL (US)

Correspondence Address: MISHRILAL L. JAIN, 11620 Masters Run, Ellicott City, MD, 21042, US

(21) Appl. No.: 10/092,576

(22) Filed: Mar. 8, 2002

Related U.S. Application Data
(60) Provisional application No. 60/273,837, filed on Mar. 8, 2001.

(51) Int. Cl. G01N 27/00; G01N 21/00

(52) U.S. Cl. 422/81; 422/82.01; 422/82.05; 422/82.08; 422/82.09; 436/149; 436/150; 436/164; 436/172

(57) ABSTRACT

An apparatus for measurement, manipulation and encapsulation or extraction of material from particles, particularly cells. The apparatus can also be used for measuring the electromechanical properties of cells, optical properties of cells, interior structure of the cell, for differentiating cells on the basis of surface markers and for cell poration using electric field or electromagnetic radiation. Optical including fluorescent emission, scatter intensity and pulse duration, and impedance measurements at multiple frequencies using multiple optodes, electrodes and conventional Coulter electrodes are made simultaneously using an integrated sensor. Cells are suspended in a fluid whose electromagnetic properties and optical properties are different from that of the cells. Cells are made to pass through a constricted path and thereby cause a measurable change on any of the electrodes or optodes monitoring the constricted volume. Optical elements are placed in a non-encircling arrangement around the constricted volume.

This application claims priority to co-pending U.S. Provisional Patent Application Serial No. 60/273837 of Shailesh P. Mehta entitled “Device for Analyzing Particles and Method of Use” filed Mar. 8, 2001.

### FIELD OF THE INVENTION

The present invention relates to a method and apparatus for measurement, manipulation and encapsulation or extraction of material from particles, particularly cells. More particularly this invention relates to an apparatus for counting, measuring, manipulating and electroporating cells suspended in a fluid whose optical or electromagnetic properties are different from that of said fluid.

### BACKGROUND OF THE INVENTION

Particle Measurement:

Peripheral blood of a human usually contains red blood cells (RBC), platelets (PLT), and white blood cells (WBC), all of which are suspended in a conductive medium commonly known as plasma. Plasma comprises proteins, anions and cations. Plasma also contains components which assist in forming blood clots. The blood in an adult usually contains about 4.5 to 5 million RBCs or erythrocytes per cubic millimeter. Mature RBCs have no nuclei and are generally shaped as circular biconcave disks with a diameter of about 7.5 to 8 microns, and a thickness of about 1.5 to 1.8 microns. RBCs contain hemoglobin, which gives blood its red color. Hemoglobin helps transport oxygen and carbon dioxide and plays a role in maintaining pH in blood. The blood in an adult usually contains about 200,000 to 400,000 platelets per cubic millimeter. Platelets are small, biconvex cellular particles whose mean volume is about 7 microns to 8 microns. Their general configuration includes a granular central portion embedded in a homogeneous matrix.

Peripheral blood also contains red cells of earlier maturation levels, which are important diagnostic indicators. Two of these are reticulocytes and nucleated red blood cells. At the earliest stage of development the red cell consists mostly of nucleus, and is referred to as an erythroblast. As the erythroblast matures, the nucleus becomes smaller, anucleolate, and more nearly spherical. Subsequent maturity involves a complete loss of nucleus. The immature red cells that retain a nucleus are referred to as nucleated red blood cells (NRBCs). The NRBC count has been useful in patient monitoring under many disease states. However, NRBCs in peripheral blood often contribute to inaccurate enumeration of the white cell count, due in part to the presence of a nucleus, which makes them difficult to distinguish from small white cells.

Reticulocytes are red cells at the maturation level just between NRBCs and mature RBCs. Reticulocytes provide a means of evaluating a patient's anemic state. Anemia usually occurs as a result of an uncompensated increase in the rate of removal of erythrocytes from blood, or a decrease in the rate at which they are formed and released into blood. An increased reticulocyte patient count in an anemic patient indicates rapid erythroid turnover, which suggests acute blood loss or hemolysis.

In normal human blood, the concentration of white cells, referred to as WBCs or leukocytes, is much lower than the concentration of red cells. The normal concentration of WBCs is approximately 7000 per micro liter. They vary in size, most of them from about 7.5 to 12.5 microns in diameter. They are more nearly spherical in shape than RBCs and usually somewhat larger in volume. WBCs may be classified generally as either granular or nongranular. The granular WBCs include neutrophils, eosinophils and basophils. The nongranular WBCs include monocytes and lymphocytes. These categories of WBCs are often referred to collectively as a “five-part differential,” and, generally, the most significant of these categories are neutrophils and lymphocytes.

Neutrophils usually comprise from about 50 to 60% of all WBCs. Their cytoplasm contains numerous minute granules, which can be stained. Under certain conditions neutrophils may leave the blood vessels and disintegrate, thereby releasing granules into the connective tissues. These granules are rich in certain enzymes, which become active and take part in the body's defense mechanism.

Lymphocytes comprise about 30% of the WBCs in humans. The nucleus of a normal lymphocyte occupies nearly the entire cell volume, and thus the cytoplasm surrounding the nucleus is a rather thin shell. Lymphocyte cytoplasm may stain with dyes due to the cytoplasms content of ribonucleic acid. Lymphocytes may leave the blood vessels and enter the connective tissue where they also constitute a part of the body's defense mechanism, playing a major role in the body's immunological responses.

There are three major “subsets” of lymphocytes that are currently clinically significant: T lymphocytes, B lymphocytes, and Natural Killer cells, also known as “large granular lymphocytes” or NK cells. Each of these subsets can be distinguished based on the existence of distinctive cell surface markers or antigens. Also, B lymphocytes have a high density of immunoglobulin of their surfaces, whereas T lymphocytes have little or none. T lymphocytes are characterized by various surface markers against which antibodies can be produced.

Categories of T lymphocytes have been identified according to their surface markers and overall function. The “helper” T cells help B cells produce certain classes of antibody molecules, and help other T cells in their immune responses. The “suppressor” T cells are regulatory cells that can suppress the responsiveness of other T or B cells. The suppressor T cells include several subsets, which are also recognized by distinct surface markers. The ability to count, size and classify blood cells is useful when evaluating the health of an individual. For example, the level of circulating CD4 lymphocytes (helper-T cells having a CD4 antigen expressed on the surface of the cell) is currently regarded as the best single predictor of progression of HIV infections. The CD4 level may be used for classifying individuals for enrollment in experimental treatment regimes, determining when anti viral therapy should be initiated, and monitoring treatment responses in clinical trials. Because CD4 lymphocyte levels may be important to some HIV-infected individuals, it is desirable to measure this parameter accurately.

In the current state of the art of cell analysis, there are two technologies used for counting and classifying cells. These are generally known as “flow cytometry” and “image cytometry.” The flow cytometry technology, which essentially consists of passing cells one at a time through a sensing zone of a flow cell, is preferred in clinical applications where patient test load is an important metric. This is mainly because it has at least an order of magnitude advantage in the number of cells that can be analyzed per second. Instrumentation incorporating flow cytometry can be further subdivided into two methods, which can be generally classified as “conventional hematology” and “fluorescence cytometry.” A primary distinction between the two methods is that conventional hematology generally distinguishes cells by means of size and shape alone using primarily impedance and light scatter technologies, whereas fluorescence cytometry uses cell nucleic acid content and/or surface antigens in addition to size and shape in distinguishing cells. Therefore the fluorescence method may be used to subdivide the cell types into finer classifications. A second distinction between the two methods is that conventional hematology gives results in absolute terms, whereas fluorescence cytometry results are in relative terms. Hematology analyzers deliver precise volumes and dilutions, and are thus able to measure absolute cell concentrations, or absolute counts of cell types per microliter of human blood. The fluorescence cytometry method gives only relative concentrations, or percentages of the various cell types.

A third distinction is that the hematology method is generally automated, whereas the fluorescence cytometric method as generally practiced today, is at best semi-automated, both in sample preparation, and in sample analysis. The fluorescence cytometry method is therefore significantly more labor intensive than the hematology method. Both methods use cell-by-cell analysis. Therefore, due to the high concentration of cells in whole blood, it is necessary to dilute the blood samples prior to analysis so that individual cells can be isolated for sensing within a flow cell.

In addition to determining the respective concentrations and relative percents of each of the above cell types and subsets, a thorough analysis of a blood sample will also provide information regarding various blood parameters and cell characteristics including, for example, the hemoglobin (Hgb) concentration, hematocrit value (Hct), mean cell volume (MCV), the total number of red and white cells and platelets per unit volume, the distribution width of red cells (RDW) and platelets (PDW), etc.

U.S. Pat. No. 2,656,508 to Coulter discloses what is commonly referred to as the “aperture impedance” or the “Coulter” principle for counting and sizing particles. An exemplary arrangement utilizing this principle is shown in FIGS. 1, 3, 5, and 7. Through a small aperture 1, the fluid 4 containing the particles in dilute suspension is aspirated from one electrically insulating vessel 3 into another similar vessel 5. This aperture 1 provides the only path for fluid or electrical communication between the two vessels 3 and 5. One electrode 7 is immersed in the fluid in the first vessel 3, and a second electrode 9 is immersed in the fluid in the other vessel 5. The passage of a particle through the aperture 1 causes a brief change in electrical impedance measured between the two electrodes 7 and 9. The magnitude of the transient resistance change, called a “resistive pulse”, is a measure proportional to the size of the particle. Several thousand particles may be measured in a few seconds, and the data may be sorted into classes to provide a distribution histogram showing the number of particles falling into each size range. However, this basic arrangement has suffered drawbacks, and drawbacks in accuracy can be significant. Coulter principle has been used for particle measurements in several other industries including ceramics; toners; dyes; powders; cement; sugar; pharmaceutical products and photographic materials. Variations in particle size can critically influence both the manufacturing processes and the characteristics of the final product.

There have been many attempts to address the drawbacks associated with this basic design. However, none of these attempts have been entirely successful. These drawbacks have resulted in limitations to the smallest particle that can be measured with a given aperture size, orientation errors, coincidence errors, trajectory errors, and extended sensing zone errors.

For small particles, the electrical and acoustic noise competes with the small resistive pulse signal generated by the particles resulting in low S/N ratio. Therefore, the smallest particle measurable by the aperture impedance principle is typically 2% of the aperture diameter. With very small apertures, such as a sub-micrometer aperture, the lower limit is higher than 2% because the noise floor rises substantially due to the increased resistance. The noise is proportional to the square root of the aperture resistance and the aperture resistance is inversely proportional to the square of the aperture cross-sectional area. Therefore, as the aperture becomes smaller, the resistance increases and so does the associated noise. Additionally, for the instruments based on this aperture impedance or electrical sensing zone method, in the measurement of small particles, thermal aperture noise continues to exceed all other noise contributions by more than an order of magnitude. Further improvements in the circuitry cannot lead to better resolution.

The prior art embodiment of FIG. 1 does not take into account the shape of the particle and this leads to an inability to obtain important information about the particles and significant particle orientation errors. The electrical response for cylindrical shaped particles measured by this aperture impedance method can be proportional to the size deduced from a calibration using spherical particles. This may be error as high as 25%. There is a complex relationship between hydrodynamic forces, deformation of particles, aperture dimensions and pressure and therefore it is not possible to relate the characteristics of the pulse to the shape of the particle.

In an attempt to get more information on the particles, prior art designs have simultaneously passed high and low-frequency currents through the aperture. While the use of appropriate filtering techniques can permit detection of both the low frequency resistance and high frequency reactance of the particle traversing the aperture, the interference created between the two separate current sources employed to create the high frequency and the low frequency current within the aperture cannot be eliminated. Any slight change in conditions can cause either, or both of the two frequencies to become de-tuned.

Further, it is known that generally, due to the hydrodynamic focusing in most instruments, elongated particles will be aligned with their elongated axis substantially parallel to the center axis of the orifice. With two particles of equal volume, one being spherical and one being elongated, the spherical particle while passing thorough the orifice will have a greater cross section perpendicular to the current flow than the elongated particle. Hence, the spherical particle will distort the field in such a manner that it will give a greater measured size than the elongated particle, despite their equal volumes.

FIGS. 1 and 2 illustrate the error in the prior art due to the difference in orientation of the particles. Aperture 1 in the insulator 2 establishes the constricted path of external electrodes. Consider a non-spherical particle 8 with its main axis along the aperture axis, and another non-spherical particle 6 with its main axis perpendicular to the aperture axis. The particle 6 with its main axis perpendicular the aperture axis would obstruct the electric field in the aperture 1 significantly more, and would result in a higher peak 10 as compared to the peak 12 of other particle 8 with its main axis along or parallel to the aperture axis. Thus, it is evident that particle size measurements for non-spherical particles can be fairly erroneous. Another limitation with prior art devices results in certain instruments counting losses of up to 20% due to random coincidences of particles in the orifice. Simultaneous presence of more than one particle in the aperture can occur without detection. The prior art neglects the coincident pulses most of the time or provides imprecise corrections. Statistical methods are used to compensate for neglecting these pulses. This inherently limits the accuracy of the instrument. FIGS. 3 and 4 illustrate the error in the prior art due to the co-incident presence of particles in the sensing zone. Assume that a second particle 15 enters the sensing zone before a first particle 17 has left the sensing zone. The result is that the pulse 16 due to the first particle 17 is superimposed with the pulse 18 due to the second particle 15 resulting in a much larger pulse 14.

An additional problem in the prior art is due to trajectory errors. This may arise due to non-uniform current density at different cross-sectional locations within the aperture of the instrument. Because of the non-uniform current density, the pulse height of the related shape depends on the path an individual particle takes through the aperture. The current density is significantly higher at the edges of the entrance and exit of the aperture. Also, the electrolyte stream velocity is higher in the center of the aperture than in the periphery due to boundary development. Some particles approaching the aperture obliquely travel close to the wall. These particles move slower than those that pass through the center of the aperture. The particles enter and leave the aperture boundaries through the zones of higher current density and may suffer shape distortions as a result of higher shear force near the wall resulting from the higher stream rate associated with the boundary layer. Errors may therefore result because pulse width measurements of larger particles moving in the center of the aperture might be quite similar to pulse width measurements of smaller particles moving near the aperture walls.

For example, a particle traveling close to the wall of the aperture produces an ‘M’-shaped pulse. The pulse-height of this particle is significantly higher in comparison to the normal pulse due to a particle traveling through the center of the aperture. The resultant size distribution of a nearly mono-sized particle population is then strongly skewed toward higher volume. A true representation of the real size of the particle thus cannot be obtained. FIGS. 5 and 6 illustrate the error in the prior art due to the difference in the trajectory of the particle passing through the sensing zone. As the field lines are concentrated near the walls, a particle following a trajectory 20 which is close to the walls, gives a pulse 24 of higher magnitude in comparison to the pulse 26 associated particle that follows a trajectory 22 close to the axis of the aperture 1.

Besides the limitation on the smallest particle that can be measured with a given aperture, and the other drawbacks described above, the dynamic range of measurement is also limited. When a particle-free electrolyte passes through the aperture, the noise generated is mainly due to the electrical noise of the amplifier system. However, the noise increases greatly when a suspension of particles passes through the aperture. The absolute value of the noise increases with the increase in the size of particles. This happens partly because the particles moving just outside the aperture alter the conductivity gradient in the aperture. If the magnitude of this disturbance is greater than the signal due to the small particles, the measurement of small particles becomes impractical. Thus, the measurable range of sizes is limited, and it becomes difficult to distinguish between large and small particles in the same suspension.

Another limitation related to this phenomenon is an extended sensing zone error that occurs due to particles moving just outside the aperture. These external particles alter the conductivity gradient in the aperture. FIGS. 7 and 8 illustrate the error in the prior art due to the disturbance of extended sensing zone by particles outside the aperture. A large particle 28 located just outside the aperture 1 can significantly alter the signal on the electrodes 7 and 9, even before it enters the aperture 1. The peak 34 produced by this particle overshadows the peak 32 of a smaller particle 30 within the aperture 1 itself. Measurement of small particles in the presence of such interfering larger particles is thus impractical, when the magnitude of the disturbance is greater than the signal associated with the small particle. Thus, the range of overall sizes that can be measured becomes limited, and the ability to distinguish between large and small particles in the same suspension is hampered.

Disturbances depend upon the turbulence of the liquid at the boundary and the fringe effects of the electrical measuring fields. One phenomenon, which should be mentioned as especially disturbing, is that turbulence exists in the container, which is located at the outlet of the channel in the through-flow direction. This turbulence recycles particles, which have already been measured back into the region of the measuring field. Particles, which have been recirculated in this manner, re-trigger a change in the measured potential difference, thus falsifying the measurement result. It has already been proposed to provide a spatial limiting of the suspension in the channel. However, the equipment suitable for exploiting this technique is extremely complicated and correspondingly expensive. U.S. Pat. No. 4,161,690 addresses the recirculation problem by triggering sampling via the Coulter electrodes when a center electrode detects the particle's passage through the middle of the channel.

Thus, there is a requirement for an apparatus which can measure particle size and other properties more accurately than existing apparatus. If the particle measurements can be done more accurately and speedily the process for separation of different particles also improves. Counting, measuring, differentiating, separating and controlling the movement of particles is very critical in numerous industries like ceramics, cosmetics, explosives, powdered fuel, metal powder, abrasive, minerals, pharmaceutical, pigments, fillers, biotechnology and the like. Various parameters like volume; shape, rigidity, resistance and reactance have become extremely important in characterizing the properties of the particles and the fluid carrying the particles.

The detection and enumeration of most of the above cell types, as well as a determination of the above cell parameters, can be accomplished by using any one of several commercially available hematology instruments. Such instruments include Beckman Coulter's GEN™, STKS™, and MAXM™ Hematology Instruments; Abbott Laboratories' Cell Dyne 3000/4000 Hematology Instruments; and Toa's Sysmex Series of Hematology Instruments. In automatically acquiring data on each cell type, all of the above-mentioned hematology instruments use at least two discrete cell-analyzing transducers. One (or more) of these transducers operates to acquires data useful in differentiating and enumerating the five different types of white cells, and another transducer is dedicated to counting and sizing of red cells, white cells and platelets in a precise volume of sample.

The respective outputs of the multiple transducers are processed by a central processing unit to provide an integrated cell analysis report. In the Beckman Coulter instruments, an electro-optical flow cell (transducer) produces signals indicative of the respective volume (V), electrical conductivity (C) and light scattering (S) properties of each white cell passing there through to provide a “five-part differential” of the five white cell types. Additional transducers operate on the Coulter Principle, one serving to count red cells and platelets in a highly diluted sample, and others serve to count white cells in a lysed sample. Information from the three transducers is processed and, in some cases, correlated (e.g., by multiplying the relative percentage of each white cell subset, as obtained from the electro-optical flow cell, by the absolute number of white cells counted by the Coulter transducer) to provide information about each cell type or subset, e.g., the concentration (number per unit volume) of each white cell subset in the whole blood sample being analyzed.

In the Abbott instruments, an optical flow cell that detects only light scatters and light polarization information provides the five-part diff information. Here, again, a pair of additional transducers operating on the Coulter Principle serves to size and count white cells, red cells and platelets. The respective outputs of the two transducers are correlated with each other to report information on different cell types and subsets. In the Toa instruments, the five-part differential information is provided by a pair of electrical flow cells (Coulter transducers) that measure only the cell's DC volume and RF conductivity. Different lysing reagents are used to differentially process two or more aliquots of the blood sample, prior to passage through the two transducers. A third Coulter transducer operates to detect and count red cells and platelets. As in the Beckman Coulter and Abbott instruments, the respective outputs of the several transducers are correlated to provide the five-part differential information.

As indicated above, conventional hematology instruments, while being capable of differentiating and enumerating the vast majority of cell types and subsets in a peripheral blood sample, cannot readily differentiate all subsets of cells, particularly those that are abnormal or immature. An “extended differential” measurement by which these abnormal and immature cells may be detected and counted can be made manually by first producing a blood-smear of a sample of interest on a glass microscope slide, staining the smear with a dye to enable the cells to be visualized, whereby abnormal or immature cells of interest can be visually differentiated from other cells, and then examining the resulting stained bloodsmear under a microscope.

Alternatively, some blood types of an extended differential measurement can be detected using a conventional flow cytometer. In such an instrument, a blood sample that has been previously prepared, e.g., by either (1) mixing the sample with fluorochrome-labeled monoclonal antibodies or the like which serve to selectively “tag” certain cells of interest, or (2) mixing the sample with a fluorescent stain adapted to selectively mark cells of interest, is passed through an optical flow cell. As each cell in the sample passes through the flow cell, it is irradiated with a beam of photons adapted to excite the fluorescent material associated with the cells of interest. Fluorescent radiation emitted by each of the labeled cells, together with radiation scattered by each cell is detected and used to differentiate the cells of interest from other cells in the sample.

Commercial, stand-alone, flow cytometers are made by Beckman Coulter, Toa Medical Electronics, Cytomation, Bio-Rad, and Becton Dickinson. It is known in the prior art to integrate flow cytometers and hematology instruments into a single automated laboratory system in which blood samples are automatically advanced along a track past these different instruments. As sample-containing vials pass each instrument, a blood sample is aspirated from each vial and analyzed by the instrument. Instrument systems combining discrete hematology and flow cytometry instruments are commercially available from Beckman Coulter and Toa Medical Electronics, reference being made to Toa's HST Series. In fluorescence flow cytometry, a suspension of previously stained or fluorescently labeled particles, typically cells in a blood or other biological fluid sample, is transported through a flow cell where the individual particles in the sample are illuminated with one or more focused light beams. One or more detectors detect the interaction between the light beam/s) and the labeled particles flowing through the flow cell. Commonly, some of the detectors are designed to measure fluorescent emissions, while other detectors measure scatter intensity or pulse duration. Thus, each particle that passes through the flow cell can be mapped into a feature space whose axes are the emission colors, light intensities, or other properties, i.e. scatter, measured by the detectors. Preferably, the different particles in the sample can be mapped into distinct and non-overlapping regions of the feature space, allowing each particle to be analyzed based on its mapping in the feature space. In this respect, flow cytometry differs from the conventional hematology instruments in that some of the feature space axis includes fluorescence emissions. As noted above, lymphocyte subclasses are health determinants. Thus, it is desirable that these and other parameters be measured accurately. Although known hematology and fluorescent flow cytometry instruments have made significant advances in the ability to characterize blood cells, a problem still faced in this area is the difficulty in obtaining accurate resolution between different types of cells.

In leukocyte analyses, it is desirable that all of the RBCs be lysed. Because RBCs outnumber WBCs by about 700 to 1, a small number of unlysed red cells may significantly distort white cell patient counts. Some reagents used to lyse red cells require too lengthy an incubation period to be practical in an automated clinical analyzer. For example, the Tris buffered ammonium chloride solution takes about 5 to 10 minutes to lyse red cells, which may be impractical for automation. Furthermore, incomplete hemolysis with certain lyric reagents may result in red cell stroma that retain sufficient hemoglobin or particulate matter to generate high background patient counts in automated clinical electro-optical systems. When this occurs, it is usually necessary to remove the WBCs to be analyzed from the red cell stroma by centrifugation, a procedure that is a limiting factor when adapting a reagent system for automation. Some currently used reagent systems require cytochemical staining of fixed WBCs before differential analysis. These systems require timed addition of multiple reagents and incubation periods and may not be generally adaptable for quantifying nucleated red cells or lymphocyte subsets. Furthermore, each step of reagent addition or other manipulation of a blood sample may decrease the precision of the final patient count obtained.

The earliest stage of RBC, the nucleated red cell, NRBC, when found in the peripheral blood on conventional hematology analyzers can be confused for a small lymphocyte, since the lysis will not destroy the nucleus of the NRBC. Because of the ratio of RBCs to WBCs, even a relatively small percentage of NRBCs can lead to substantial error in the WBC and lymphocyte count. This may be troublesome in neonate or pediatric samples, in which the presence of NRBCs in peripheral blood is a normal condition. For this reason, the laboratory may do manual slide inspections on some of these samples. Conventional hematology analyzers are only able to flag these samples by noting the spreading out of the usual lymphocyte scatter cluster. The manual inspection results in a count of the number of NRBCs per 100 nucleated cells. This percentage is then used to correct the analyzer WBC count. Clearly the need exists for an accurate automated count of NRBCs. A manual method of identifying and counting reticulocytes involves precipitating the RNA with a stain. A smear is pulled from the stained blood and manually examined under a microscope. The precipitated RNA appears as intracellular dots or filaments. Manually counting 1,000 RBCs under a microscope and dividing those qualifying as reticulocytes by 10 determine reticulocyte %. Both the precision and the accuracy of this manual method are less than desirable. There may be considerable variation in identification of reticulocytes as well as variation in counting techniques. Accordingly, there is a need for a cell analysis system that addresses the deficiencies described above.

In U.S. Pat. Nos. 5,631,165 and 5,656,499, an attempt is made to fully integrate the respective functions of hematology and flow cytometry instruments into a single instrument. Such an instrument comprises a plurality of transducers, including an optical flow cell adapted to make fluorescence and multiangle light scatter measurements, an electrical impedance-measuring transducer (a Coulter transducer), and a calorimeter for measuring the overall hemoglobin content of a blood sample. The respective outputs from these transducers are processed and correlated. As suggested above, the requirement to correlate the respective outputs of multiple transducers in order to report certain characteristics of a cell type or subset can, under certain circumstances, be problematic in that it introduces an uncertainty in the analytical results. The validity of the requisite correlation step presupposes that the sample processed by one transducer is identical in content to that processed by the other transducer(s). This may not always be the case. Ideally, the same transducer should make all of the measurements made on a cell simultaneously. In such a case, there would be no need to correlate data from independent or separate transducers. Further, the simultaneous measurement of multiple parameters on a single cell using a single transducer enables a multidimensional cell analysis that would not be possible using separate transducers, or even using a single transducer when the parameter measurements are spatially separated in time. The desirability of using a single electro-optical transducer to simultaneously measure the volume (V), conductivity (C), light scatter (S) and fluorescence (F) of a single cell has been suggested in the prior art. As noted above, such a transducer offers the advantage of making all measurements simultaneously on the same cell, rather than making some measurements on one cell with one transducer, making other measurements on another cell of the same type using another transducer, and then attempting to correlate the results from the two transducers to draw certain conclusions about the cell sample.

Rodriguez, et al. in U.S. Pat. No. 6,228,652 describe a blood measuring instrument that includes single transducer for simultaneously measuring the DC volume, RF conductivity, light scattering and fluorescence characteristics of blood cells passing through a cell-interrogation zone.

Need for Manipulating Cells:

Cellular transformation is important to many industrial sectors. Production of pharmaceuticals through transformation biotechnology is an emerging focus area. Plant, mammalian, and bacterial colonies are genetically transformed to produce desired pharmaceuticals and pharmaceutical precursors. Chemical producing bioreactors using transformed organisms as production units are also emerging as a significant component of this industrial sector. The genetic transformation of economically significant crops is also a major biotechnology research thrust area. There are significant benefits to be achieved by introducing material into cells. For example by encapsulation of allosteric effectors of hemoglobin in erythrocytes can lead to significant medical benefits. Accordingly, numerous devices have been designed to assist or simplify the encapsulation procedure.

For example much effort has been recently focused on the development of procedures for the targeted delivery of pharmaceutical agents to specific sites in a patient. It is known that drug efficacy can be increased when the appropriate target site is efficiently reached, and drug toxicity can be reduced when the total amount of drug administered is minimized. The interest in drug delivery systems applies both to conventional agents, many of which are relatively simple organic molecules, as well as to more complex agents such as oligopeptides, proteins and nucleic acids, etc.

One area of recent interest relates to the use of red blood cells (hereafter erythrocytes and RBCs) to deliver therapeutic dosages of drugs to a target site in a patient. Erythrocytes can be “loaded” with biologically active agents by a process in which the cell membranes of the erythrocytes are lysed and one or more agents is added to the erythrocytes, followed by resealing of the cell membranes. Such “loaded” or “carrier” erythrocytes offer a number of advantages as drug delivery and targeting systems because they are biodegradable, can be maintained in the circulatory system for long periods of time, and can be targeted to selected cells such as, for example, macrophages. However, although many have investigated the use of erythrocytes as drug delivery systems, the method has not yet developed to the point where it can be applied routinely in a clinical setting.

The ability to isolate specific sub-populations of cells from cell suspensions is of critical importance to many applications in the biological sciences as well as to many therapies in clinical medicine. For example, the basis of many medical therapies for treating a variety of human diseases and for countering the effects of a variety of physiological injuries involves the isolation, manipulation, expansion, and/or alteration of specific biological cells. One particularly important example involves the reconstitution of the hematopoietic system via bone marrow or progenitor cell transplantation. More specific examples include: autologous, syngeneic, and allogenic stem cell transplants for immune system reconstitution following the myeloablative effects of severe high dose chemotherapy or therapeutic irradiation; severe exposure to certain chemical agents; or severe exposure to environmental radiation.

The inability to effectively transform organisms through integration of desirable genetic information into the genome of cells is a significant limitation to genetic research, acting as a bottleneck to the otherwise rapidly developing field of biotechnology. There are multiple methods for encapsulation or extraction of the material from cells. They include methods like micro-projectile bombardment, liposome based transfection, retroviruses, chemical methods, osmotic pulse techniques and electroporation.

Electroporation:

Electroporation is a technique that is used for introducing chemical species into biological cells, and is performed by exposing the cells to an electric potential that traverses the cell membrane. Electroporation involves the breakdown of the cell membrane lipid bilayer leading to the formation of transient or permanent pores in the membrane that permit the chemical species to enter the cell by diffusion. In some cases the electric potential is applied in pulses, and whether the pore formation is reversible or irreversible depends on such parameters as the amplitude, length, shape and repetition rate of the pulses, in addition to the type and development stage of the cell.

As a method of introducing chemical species into cells, electroporation offers numerous advantages: it is simple to use; it can be used to treat whole populations of cells simultaneously; it can be used to introduce essentially any macromolecule into a cell; it can be used with a wide variety of primary or established cell lines and is particularly effective with certain cell lines; and it can be used on both prokaryotic and eukaryotic cells without major modifications or adaptations to cell type and origin. Electroporation is currently used on cells in suspension or in culture, as well as cells in tissues and organs.

Studies have shown that large size nucleotide sequences (e.g., up to 630 kb) can be introduced into mammalian cells via electroporation. However, the efficiency of electroporation, as reflected in the current literature, is usually low (see U.S. Pat. No. 5,019,034, herein incorporated by reference). A typical result is from about 5 to 20 percent transfection depending on conditions, parameters and cell type. Creation of a high efficiency method and apparatus for the transfer of nucleic acid and the introduction of other preselected molecules into living cells is desired.

The incorporation of drugs into red blood cells via electroporation as well as the incorporation of genes into white blood cells via electroporation has been demonstrated. The selective incorporation of genes into white blood cells in whole blood via electroporation has also been demonstrated.

Electroporation is currently performed by placing one or more cells, in suspension or in tissue, between two or more electrodes connected to a generator that emits pulses of a high-voltage electric field. The pore formation, or permeabilization, of the membrane occurs at the cell poles, which are the sites on the cell membranes that directly face the electrodes and thus the sites at which the trans membrane potential is highest. Unfortunately, the degree of permeabilization occurring in electroporation varies with the cell type and also varies among cells in a given population.

The electric field strength of an electric impulse is calculated by dividing the voltage by the distance between the electrodes. For example, if the voltage is 100 V between two electrode faces that are 0.01 cm apart, then the field strength is 10 kV/cm. Each cell has its own critical field strength for optimum electroporation. This is due to cell size, membrane makeup and individual characteristics of the cell wall itself. For example, mammalian cells typically require between 0.5 and 5.0 kV/cm before cell death and/or electroporation occurs. Generally, the required field strength varies inversely with the size of the cell.

When electroporation is performed in large populations of cells whose properties vary among the individual cells in the population, the electroporation conditions can only be selected to address the average qualities of the cell population; the procedure as currently practiced cannot be adapted to the specific characteristics of individual cells. Of particular concern is that under certain conditions, electroporation can induce irreversible pore formation and cell death. A high electric field, for example, may thus produce an increase in transfection efficiency in one portion of a cell population while causing cell death in another.

Four phenomenons appear to play a role in the process of electroporation. The first is the phenomenon of dielectric breakdown. Dielectric breakdown refers to the ability of a high electric field to create a small pore or hole in a cell membrane. Once a pore is created, a cell can be loaded with biologically active substances. The second phenomenon is the dielectric bunching effect, which refers to the mutual self-attraction produced by the placement of vesicles in a uniform electric field. The third phenomenon is that of vesicle fusion. Vesicle fusion refers to the tendency of membranes of biological vesicles, which have had pores formed by dielectric breakdowns, to couple together at their mutual dialectic breakdown sites when they are in close proximity. The fourth phenomenon is the tendency of cells to line up along one of their axis in the presence of high frequency electric fields. Thus, electroporation relates to the use in vesicle rotational prealignment, vesicle bunching and dielectric constant or vesicles for the purpose of loading and unloading the cell vesicle.

However, with the conventional electroporation process, the cells are more or less damaged, so that the frequency of the cell division of the cells is reduced. As a result, the efficiency of the transformation by the electroporation is not satisfactorily high. One of the causes of the reduction in the cell division frequency is the damage of the cells directly given by the application of the high voltage. This drawback is thought to be inherent to the electroporation itself and may not be overcome. However, it is thought that this is not the only cause of the reduction in the cell division frequency. Thus, it is expected that eliminating such other causes may considerably increase the frequency of the cell division.

Schoenbach et al in U.S. Pat. No. 6,326,177 describe a method for intracellular electromanipulation. The method includes applying at least one ultrashort electric field pulse to target cells. The ultrashort electric field pulse has sufficient amplitude and duration to modify sub-cellular structures in the target cells and does not exceed the breakdown field of the medium containing the target cells. The amplitude and duration of the ultrashort electric field pulse are typically insufficient to substantially alter permeability of the surface membranes of the target cells, e.g., by irreversibly disrupting the cell surface membranes.

U.S. Pat. No. 4,224,313, (Zimmermann et al.), discloses a method for preparing a mass of loaded cells suspended in a solution by increasing the permeability of the cell membranes via externally induced osmotic pressure or an electric field, or both. The material to be loaded includes a pharmaceutical agent having a capability, when incorporated in a cell, of prematurely destroying cell membranes, and a stabilizing agent capable of inhibiting the reaction of the pharmaceutical agent with the cell membranes.

Calvin in U.S. Pat. No. 5,098,843 has proposed the electroporation of cells in a flow-through system utilizing a venturi in a static field. Calvin Noel describes high efficiency electroporation accomplished by the generation of a high voltage electrical pulse with precise characteristics determined necessary to optimize cell transformation and the application of such pulse to a sample of such suspension or by continuous flow of the suspension through a static electrical field under flow conditions to simulate the precise characteristics of such high voltage pulse. Thus, the suspension, whether treated as a non-flowing sample or as a continuous flow liquid suspension of cells in admixture with DNA, is subjected to a high intensity electric field at its maximum intensity in no more than about 100 microseconds and thereafter to reduced field intensity to zero field intensity in no more than about 5,000 microseconds. The high intensity pulse, or static electrical field with suspension flow there through simulating the characteristics of such pulse, porates the wall of the cells in suspension thereby allowing the introduction of DNA into the cells with a high survival rate for such cells.

Spohr R in U.S. Pat. No. 4,778,657 describes an apparatus for determining various characteristics of particles suspended in a liquid, e.g., the deformability or other values of red blood corpuscles. The particles are transported by a method similar to the Coulter method through a measuring channel having sections that are constricted or widened over the length of the measuring channel in, e.g., a foil. The change of certain electrical characteristics of the liquid is measured during passage of each particle, which furnishes a measure of the desired particle characteristics. The volume, as well as the deformability and other characteristics, of a particle can be determined during one passage through one and the same measuring channel.

Groves M R in U.S. Pat. No. 4,525,666 describes a particle analyzing apparatus for studying a stream of membrane-sheathed particles in liquid suspension wherein, for a given particle, a first particle pulse signal is obtained from a first sensing aperture having a first low frequency electrical field with an intensity below that causing particle electrical breakdown; a second particle pulse signal is obtained from a second sensing aperture having a second low frequency electrical field with an intensity equal to or greater than that causing particle electrical breakdown; a third particle pulse signal is obtained from one of the sensing apertures by having a high frequency electrical field therein or, alternatively, from a third sensing aperture having a third low frequency electrical field with a second and different intensity equal to or greater than that causing particle electrical breakdown. The three signals are correlated on a cell-by-cell basis and are used to determine the particles' apparent breakdown field intensity size and opacity, which in turn can yield particle volume, shape and internal conductivity.

A problem with known methods of electroporation is that the efficiency of transfection by electroporation can at times be low. In the case of DNA, for example, a large amount of DNA is needed in the surrounding medium to achieve effective transformation of the cell. Achieving the highest possible efficiency of transformation is of particular advantage in circumstances where large numbers of transformants are required or transforming DNA is in limited supply. For example, a mutant host strain is often transformed with a plasmid-based genomic library as a means to isolate and identify the wild-type gene corresponding to the mutant allele. Typically, tens of thousands of transformants are required in such an experiment and the library DNA is often in limited supply. Such DNA libraries can, in principal, be amplified to produce more DNA, however, this is undesirable because each round of amplification results in a degradation of the representation of the library and lessens the chance that the gene of interest will be found. Thus, any improvement in transformation efficiency reduces consumption of precious and often irreplaceable DNA preparations.

Further, while many wild-type laboratory strains transform well with established methods, very often introduction of a desired mutation into a strain results in a concomitant reduction of the strain's transformation efficiency. In some cases, mutant strains can be completely refractory to transformation by established methods.

Cell Lysis:

Due to the development of the technology of gene recombination in the medical industry, biological formulations are being manufactured by gene recombination. For example, many protein liquid factors, such as human insulin, interferon which is becoming widely used for the medical treatment of hepatitis, or interleukin which is regarded as a carcinostatic, are being used as medicines to remedy previously incurable disease. These protein factors are manufactured by incorporating a human gene into a fungus such as calibacillus, having the fungus produce the protein factors, and then either by incorporating a separate gene which ejects the object constituents out of the fungus or by dissolving the fungus with another enzyme to recover the object constituents. Arisawa in U.S. Pat. No. 5,891,694 describe an apparatus for recovery of proteins and nucleic acids which are subsequently separated by liquid chromatography or thin layer chromatography. Procedures for lysing samples are known by the expert and can be chemical, enzymatic or physical in nature. The present invention allows lysis of cells on a selective cell-by-cell basis by stressing the cells under high electromagnetic field or electromagnetic radiation.

Chen in U.S. Pat. No. 5,702,432 describes an approach where, heparinized venous blood is treated with a photosensitizing agent such as 8-methoxypsoralen. The photosensitizing agent, which is preferentially absorbed by abnormal or malignant T-cell lymphocytes that are to be destroyed and exposed to UVA light having a waveband corresponding to an absorption waveband of the psoralen.

Scientific research has indicated that the actual breakdown voltage V_{c} across the membrane remains relatively constant. Cell shape factor variations will be reflected in both the apparent cell size and the breakdown field, E_{c}. Hence, the determination of the breakdown field E_{c} or membrane voltage V_{c}, according to the teachings of the present invention, can be particularly useful. For instance, it has been found that the breakdown field E_{c} can be dependent upon cell age. The older, denser cells are more resistant to the electrical field, which results from their inability to deform as much as younger cells. Stressing the cells under different conditions and measuring the response of cells can be used as a diagnostic tool and can lead to early identification of diseases.

For bone marrow transplant there is a need for effective cell separation methods to enrich the transplant tissue in stem cells and reduce the number of undesirable and deleterious cells (e.g. mature T cells for allogeneic transplants and residual cancerous cells for autologous transplants). For example, for autologous adjuvant stem cell transplant therapy following myeloablative cancer treatments, it is believed that reinfusion of residual tumor cells is a major cause of post therapy relapse. Clearly, removing such cells from transplanted tissue would be beneficial to the patient. A number of cell isolation, cell separation, and cell purging strategies have been employed in the prior art for purifying or removing cells from a suspension. Prior art cell separation methods used to isolate cells or purge cell suspensions typically fall into one of three broad categories: physical separation methods typically exploit differences in a physical property between cell types, such as cell size or density (e.g. centrifugation or elutriation); chemical-based methods typically employ an agent that selectively kills or purges one or more undesirable cell types; and affinity-based methods typically exploit antibodies that bind selectively to marker molecules on a cell membrane surface of desired or undesired cell types, which antibodies may subsequently enable the cells to be isolated or removed from the suspension.

While physical separation methods can be advantageous with regard to their ability to separate cells without causing undo damage to desired cells, current physical separation methods typically have relatively poor specificity and do not typically yield highly purified or highly purged cell suspensions. While many chemical and affinity methods have better selectivity than typical physical methods, they can often be expensive or time consuming to perform and can cause considerable damage to, or activation of, desired cells, for example stem cells, and/or can add undesirable agents to the purified or isolated cell suspensions (e.g. toxins, proliferation-inducing agents, and/or antibodies). An additional potential problem with antibody-based cell separation techniques typically employed for purification of stem cells, is that they select stem cells solely on the basis of cell surface markers (e.g., CD34) and will not select cells lacking such markers.

In addition to cancer therapy, there are a number of other important medical therapies which exist, or are under development, that are based on cells derived from a variety of different types of stem cells. Examples include pre-exposure prophylaxis or post-exposure therapies under development for a variety of biological exposures that may occur naturally (e.g., viral exposure for example with Ebola, etc.) or be inflicted by mankind (i.e., biological warfare agents). A variety of gene therapies involving genetically manipulated stem cells are being contemplated or are under development for treating a variety of blood-related diseases (e.g., AIDS, leukemia, other cancers, etc.). Gene therapy techniques based on genetically manipulated stem and/or germ cells may also be useful in cloning organisms, such as animals. However, genetically manipulating stem cells using many current technologies is difficult, typically employing viruses or gene carriers that can be time consuming and expensive, or may be dangerous to perform and may not have high yields.

Current research findings also suggest that the practical implementation of animal organ transplants into human recipients also may require procedures involving stem cells from both the donor and recipient. Many of these promising therapies would require cryopreservation and storage of donor specimens including human stem cells, for example, as derived from the stem cell-rich umbilical cord blood of newborns, which can provide such donors with a therapeutic basis for hematopoietic reconstitution or gene therapy should a health emergency occur later in life. If such storage demands are to be realistically met, the specimens will need to have minimal volume, and, therefore, successful implementation of such technologies may rest on the development and availability of effective methods for isolating trace numbers of stem cells from sources such as umbilical cord blood and the fetal liver. In order to achieve broad implementation of the therapies discussed above and others, rapid and cost effective methods are needed to isolate, with high purity, desired target cells from suspensions having a diverse mix of cell types and concentrations.

A fundamental limitation of existing transformation methodologies is the inability to precisely control delivery on a selective basis at a high throughput. For instance, optimal electroporation protocols are a fine balance between effective delivery, and the destruction or loss of viability of cells due to excessive damage during the electroporation procedure. The pores created are often too large and cannot be resealed; or fail to close quickly enough to prevent excessive influx of surrounding media into the cells, resulting in cell swelling and death.

Many of the problems identified above are a consequence of the fact that the transformation process can not be controlled in real time and the methods can not be customized on the basis of variation in individual cells. Most of the methods lack a feedback loop which is very critical if the process has to be controlled effectively. These and other deficiencies of current methods of incorporating and extracting material from the cell(s) are addressed by the present invention.

Definitions:

In applicant's invention, “cells” refers to any region surrounded by a boundary layer with mechanical functionality (i.e. resistance to deformation, tensile strength, mechanical stability, chemical resistance) determined by the ordered arrangement of the atomic bonding within the boundary layer. In addition to the cellular boundaries of membranes and cell walls, the use of the term “structure” provides the application of the methodology to other bounded regions including liposomes, micelles, cell nuclei, cell organelles, pollen, bacterial cell walls, living and dead cellular husks, viruses and viral particles, protein coated particles (capsids), sperm and egg cells.

The term “biological cell” as used herein has its commonly understood meaning and includes viable, potentially viable, or previously viable cells derived from a biological sample. Such cells include prokaryotic cells such as bacteria, and algae, and eukaryotic cells, such as yeasts, fungus, plant cells, and animal cells. Such cells typically have an inner, electrically conducting core comprised of cytoplasm, surrounded and enclosed by at least one dielectric membrane, for example the cytoplasmic or, equivalently, plasma membrane. Eukaryotic cells, in addition, typically also possess a dielectric nuclear membrane surrounding a conductive nucleus within the interior of the cell. Through out the document cells and structures are used interchangeably.

The term “dielectric layer,” or “dielectric membrane,” or “membrane” as used herein refers to a continuous layer or coating having a finite thickness and having an electrical resistivity exceeding that of a conducting core which the membrane encloses. Typically, the electrical resistivity of the dielectric layer will exceed that of the inner conducting core by at least a factor of 10, and more typically, for example as is the case with most biological cells, by at least a factor of 10⁴-10⁹ In the context of biological cells, the dielectric layer is defined by at least one lipid bilayer membrane, together with any associated structures or substances associated therewith which affect the effective membrane thickness or resistivity of the dielectric layer. “Effective,” as used herein in the context of membrane thickness or resistivity, refers to a thickness or resistivity of an equivalent membrane not possessing any associated structures or substances affecting its dielectric properties associated therewith that possesses the same dielectric properties as the actual membrane having such associated structures or substances.

The term “substrate” used herein means an insulating or semi conducting material. The term “optode” used herein means an optical element capable of delivering electromagnetic radiation or measures the change in electromagnetic radiation in the constricted volume.

The term “optrode” used herein means either an electrode or optode or a combination thereof.

The term “active” used herein means electrodes or optodes which establish electromagnetic field or introduce electromagnetic radiation in the constricted volume.

The term “passive” used herein means electrodes or optodes which measure the change in electromagnetic field or electromagnetic radiation in the constricted volume. An optrode can be in both active and passive modes simultaneously.

The term “constricted path” used herein means a volume between a pair of active electrodes or optodes in which a substantial electromagnetic field or electromagnetic radiation is restricted.

An “encircling” arrangement is a physical relationship between two elements, e.g., optrodes, where one element entirely or substantially entirely extends around and encircles the other element. A “non-encircling” arrangement is any physical relationship between two elements other than an encircling arrangement.

The term “substantially unobstructed” with respect to the flow of fluid through an aperture, channel, or other fluid conduit, means that the fluid is free to travel through the channel without getting obstructed by any element spaced inward and spaced from the side wall or walls of the aperture, channel, or other fluid conduit.

Material of interest include plasmid vectors, nucleic acids, and other macromolecules, including pharmacologically active compounds, labeling dyes, proteins and enzymes, carbohydrates and lipids. These include, but are not limited to, peptides, oligopeptides, polypeptides, proteins, hormones, corticosteroids, glucocorticoids, non-steroidal antiinflammatory agents, glutathione, cytokines, toxins, oligonucleotides and other nucleic acids, and nucleoside analogs that are well known as useful therapeutic agents. These include 6-mercaptopurine (6-MP) or azathiopurine and fludarabine phosphate, which are commonly used as immunosuppressants and inhibitors of malignant cell growth, and phosphorylated azidothymidine (AZT), dideoxycytosine (ddC) and dideoxyinosine (ddI), which are useful as anti-viral agents, particularly in the treatment of AIDS. Material of interest are also referred to as “biologically active agents” in the following pages.

The term “inactivating” as used herein refers to destruction of at least one property of a discrete object. In the context of biological cells, inactivating is equivalent to rendering unviable, or killing the cell. As applied to non-cell discrete objects, inactivate can refer to physical destruction of the object, or simply a destruction of the permi-selective diffusional barrier properties of the dielectric layer with respect to at least one molecular, ionic, or atomic species. In certain embodiments involving cells, inactivation may involve not only rendering the cells non-viable, but also irreparably lysing and physically disrupting and destroying the physical structure of the cell.

### SUMMARY OF THE INVENTION

The present invention relates to a method and apparatus for measurement, manipulation and encapsulation or extraction of material from cells. The apparatus can also be used for measuring the electromechanical properties of cells, optical properties of cells, interior structure of the cell, for differentiating cells on the basis of surface markers and for cell poration using electric field or electromagnetic radiation. Optical including fluorescent emission, scatter intensity and pulse duration, and impedance measurements at multiple frequencies using multiple optodes, electrodes and conventional Coulter electrodes are made simultaneously using an integrated sensor.

Thus, It is a further objective of the invention to improve the dynamic range of measurement, to characterize particles at multiple frequencies, to obtain information on shape of particles, and to measure more accurately the velocities of particles flowing through an aperture.

It is a further objective of the invention to improve the signal-to-noise ratio by using signal correlation techniques and providing on-chip signal analysis circuitry.

It is a further objective of the invention to get detailed information on the optical properties of the cells.

It is a further objective of the invention to get detailed information on the inside structure of the cells.

It is a further objective of the invention to control the cell poration by a feedback loop on a cell-by-cell basis.

It is a further objective of the invention to do impedance computer tomography and optical tomography on individual particles to get detailed information on the shape and internal structure of the particles.

It is an object of the present invention to provide an apparatus for encapsulating or extracting material from cells.

It is another object of the present invention to provide an apparatus that produces a modified cell population from which all exogenous non-encapsulated biologically-active substances have been removed.

It is a further object of the present invention to provide a composition suitable for use in the treatment of conditions and/or disease by encapsulating drugs into cells.

It is a further object of the invention to provide carrier (i.e., drug-loaded) erythrocytes that possess the ability to persist, and to release biologically active agents, under mammalian physiological conditions.

It is a further object of the invention to facilitate cell separation by isolating or purging based on physical differences between different cell types present in a suspension. Furthermore, the invention provides systems and methods that enable selective isolation of viable cells, selective cell inactivation, as well as stem cell electropermeabilization, using a combination of cell stressing means.

Other objects, features, and advantages of the present invention will become apparent upon reading the following detailed description of the preferred embodiment of the invention when taken in conjunction with the drawings and the appended claims.

### BRIEF DESCRIPTION OF THE DRAWINGS

The invention can be better understood in the light of various features and aspects described in the illustrations wherein:

FIG. 1 illustrates the error in the prior art due to the difference in orientation of the particles;

FIG. 2 as a graphical illustration of the errors occurring from FIG. 1;

FIG. 3 illustrates the error in the prior art due to the co-incident presence of particles in the sensing zone;

FIG. 4 as a graphical illustration of the errors occurring from FIG. 3;

FIG. 5 illustrates the error in the prior art due to the difference in the trajectory of the particle passing through the sensing zone;

FIG. 6 as a graphical illustration of the errors occurring from FIG. 5;

FIG. 7 illustrates the error in the prior art due to the extended sensing zone being disturbed by particles outside the aperture;

FIG. 8 as a graphical illustration of the errors occurring from FIG. 7;

FIG. 9 is a perspective view of the transducer with a set of optrode array;

FIG. 10 is a cross sectional view of the transducer taken through line 10-10 of FIG. 9 illustrating a possible position of optrodes on the aperture;

FIG. 11 is cross sectional views of FIG. 9 taken in a direction transverse from FIG. 10;

FIG. 12 is a sectional view of an alternative embodiment of the transducer where optrodes are formed by apertures along the plane perpendicular to the longitudinal axis of the aperture, with each supplemental aperture planar an electrode similar to the external electrode;

FIG. 13 schematically shows an embodiment of the invention for measuring light scatter and fluorescence.;

FIG. 14 shows an alternative embodiment where optodes are used for obtaining cell image,

FIG. 15 is a sectional view of an alternative embodiment of the transducer with one side of the planar electrode being covered by an insulator coating;

FIG. 16 illustrates detailed structure of one form of a wave-guide;

FIG. 17 is a sectional view of an alternative embodiment of the transducer showing optodes placed around the circumference of the orifice.;

FIG. 18 is a sectional view of an alternative embodiment of the transducer with electrodes for focusing the field of the optrode array;

FIG. 19 is a sectional view of an alternative embodiment of the transducer with multiple (two) sets of optrodes array along the axis of the aperture;

FIG. 20 is a sectional view of the transducer showing two particles entering the aperture simultaneously and being separated in space as they emerge at the end of the aperture because of radial velocity components;

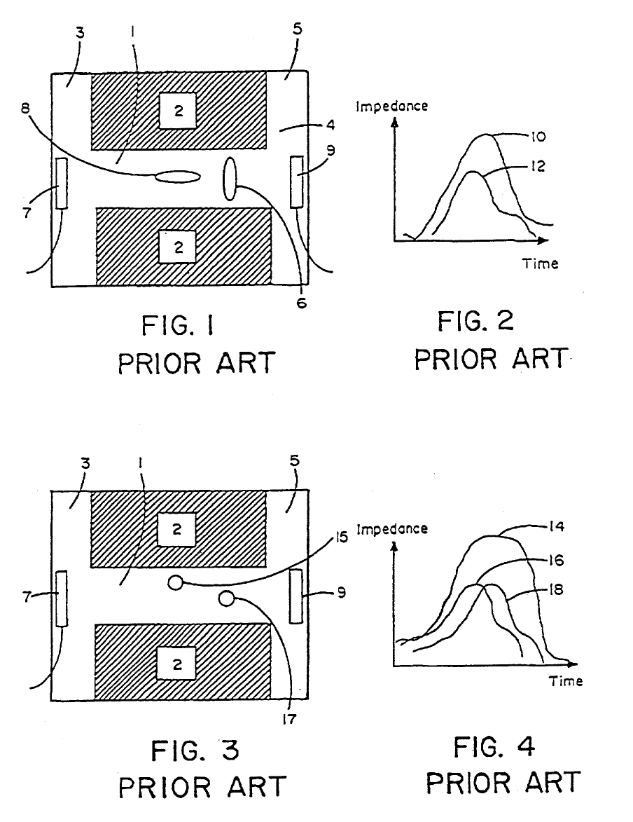

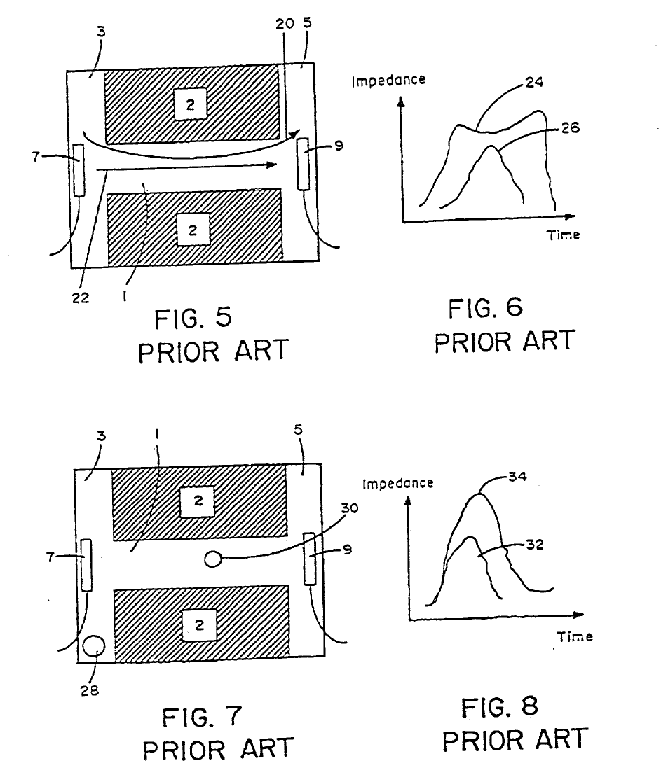

### DETAILED DESCRIPTION OF THE INVENTION

The method of operation of the apparatus of the present invention is described below with reference to the preferred use of the apparatus. It is to be understood that the apparatus may be adapted to accommodate any cell populations or vesicles, liposomes, membrane based structures and other biologically active substances. Additionally, the apparatus maybe adapted to be used in combination with any other methods of measurement and manipulation of cells.

One of the basic requirements of the invention is that there must be a difference between the electrical conductivity or the optical properties of the particle and the fluid in which it is suspended. Conductivity difference between the fluid and the particles can be changed by using any well-known method. For example, this can be done simply by adding an electrolyte to the fluid to increase its conductivity or by diluting the fluid with other nonconducting fluids such as distilled water to decrease its conductivity. The suspension is preferably diluted to a point where the particles suspended in the fluid medium are relatively scattered. This ensures that during particle measurement there will be a reduced possibility of two particles being present in the sensing zone simultaneously.

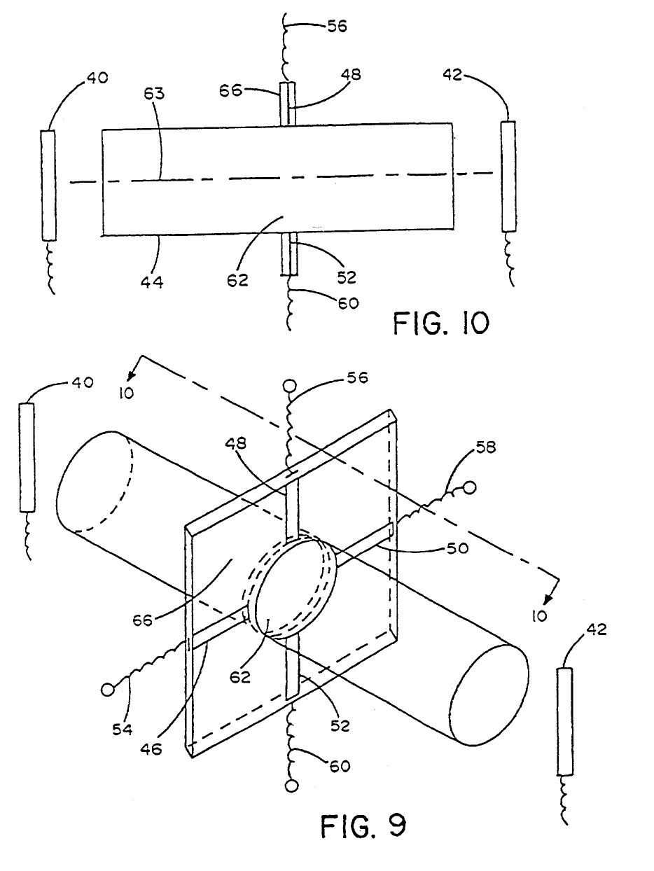

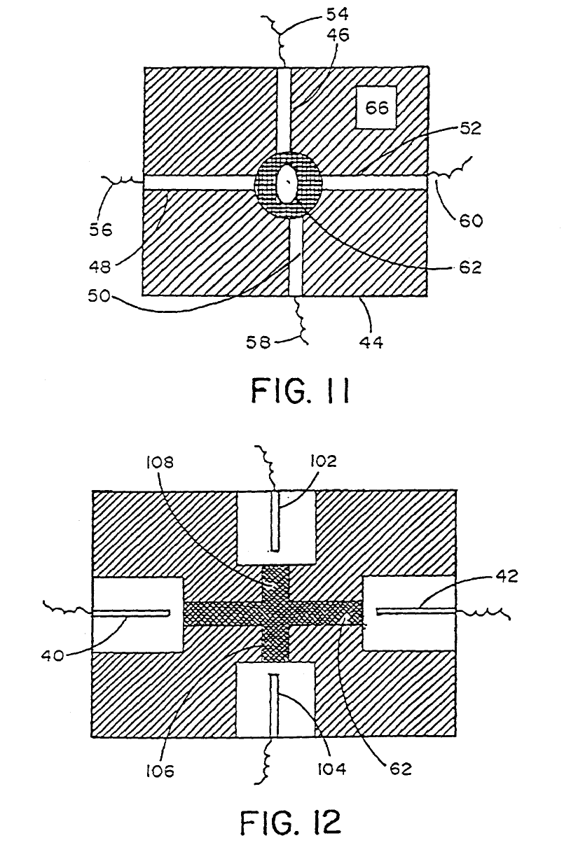

FIGS. 9-11 are schematic views of the transducer (not to scale) illustrating the position of the optrodes in relation to the standard Coulter electrodes (external electrodes). FIG. 9 is a perspective view of the transducer with a set of optrode array. FIGS. 10 and 11 are sectional views of the transducer illustrating a possible position of optrodes on the aperture. Transducer 44 is sealingly provided between two insulating containers, vessels, or other fluid holding elements, not shown, that contain external electrodes 40 and 42 respectively. The only path for the passage of current from external electrode 40 in one container to the external electrode 42 in other container is through the conduit or aperture 62 in the transducer 44. The only path for the passage of the fluid sample from one container to another is through the aperture. This establishes a constricted path of external electrodes within the aperture and along its longitudinal axis. In some embodiments in prior art optical elements are used for making optical measurements and will generally be referred to as external optodes.

The hole or aperture in the transducer may be cylindrical or of any other suitable shape. A cylindrical hole helps in maintaining a uniform flow through the transducer and establishes an axially symmetrical field for external electrodes. However in some cases where optical measurements are being made a square hole is employed. A hole can be easily made by ultrasonic drilling, laser drilling, etched particle track process, standard techniques of micro-electronics like wet or dry plasma etching, electron beam milling and the like. The aperture is shown much larger in comparison to the external electrodes to illustrate the details of the design.

In addition to the external electrodes 40, 42, optrodes 46, 48, 50, 52 are placed on or immediately adjacent to the internal wall, e.g., the circumference, of the aperture 62. Optrodes are coupled to signal generating circuitry 51 and signal analysis circuitry 53 through connections 54, 56, 58, 60. A constricted path is established by coupling the output of the signal generating circuitry 51 to any pair of active optrodes. The passage of a particle through the constricted path causes a measurable change in current or voltage at passive electrodes or a measurable change at the optodes. The passive optrodes are coupled to signal analysis circuitry 53. Any of the planar or external optrodes can be used in active or passive mode, and as described below, the optrodes can be switched between operation as an active electrode and a passive optrodes. The change in signal may also be measured at the active electrode itself, which may be advantageous in certain applications. Only the tip of the electrode facing the hole is exposed to the fluid. The area of conducting material that is exposed to the fluid in the aperture is preferably between from 1 micron square to a few hundred micron squares. If the suspending fluid is an electrolyte, reducing the area of electrode that is exposed to the fluid results in a rising value of the electrode-electrolyte impedance at the electrode-fluid interface. Electrode-electrolyte impedance is inversely proportional to the area. There are numerous techniques known in the art for increasing the effective area of the metals such as coating with platinum black. To distinguish a signal from the noise of the passive electrode, a significant current should be flowing through the electrodes. Precautions should be taken to avoid polarization of this small electrode. The effects of polarization can be reduced by using a high frequency AC voltage rather than DC voltage, or by creating the constricted path for a shorter duration. Any variations in the electrode area can be compensated for by suitably adjusting the gain associated with that electrode.

When optrodes 46, 48, 50, 52 are used in the active mode, they establish another constricted path. If the active pair is located opposite from each other, they establish a constricted path transverse and substantially perpendicular to the longitudinal axis of the aperture. In many applications it is advantageous to use a floating signal source to minimize the interference between multiple constricted paths. Two or more optrodes 46, 48, 50, and 52 may be used for establishing the constricted path and this is subsequently referred to as a constricted path of optrodes. The constricted path can also be made using a combination of planar and external electrodes or a combination of optrodes in different planes. The constricted path of optrodes and constricted path of external electrodes can be established simultaneously or independently of each other. The constricted path can be electrical which is generated by feeding current (or applying a voltage) through active optrodes and then measuring the resulting variation in voltage (or current) as particles pass through the constricted electrical path or it can be optical where active optrodes inject electromagnetic radiation in the constricted path. The simple occurrence of a pulse caused by particles entering and subsequently leaving the constricted path allows the number of particles to be counted. The size of the particle may be derived from the magnitude of the pulse. The aperture size is normally chosen such that the majority of particles preferably lie within 2% to 60% of the aperture diameter for electrical measurements.

When a particle enters the constricted electrical path, the resistance between the measuring electrodes rises if the resistivity of the particle is more than that of the fluid in which it is suspended, which is preferable. Thus, whenever a particle is present in the constricted path 64, it modifies the electric field and this change may be measured at passive electrodes located in the constricted path or by measuring the voltages the electrodes generating the constricted electrical path. The passive optrodes 48, 52, not used for creating the constricted electrical path, are said to be in a passive mode. Both external and optrodes may be used for measuring the change in the electric field within the aperture due to the passage of the particle. In one embodiment, the optrodes on one plane are used in passive mode and measure the signal due to the passage of a particle through the constricted path established by external optrodes or the constricted path of another pair of optrodes.

All of the electrodes may also be used as the passive electrodes. In such an arrangement, whenever a particle passes through the constricted path along the length of the aperture, it alters the impedance between the external electrodes. This results in a measurable change in current/voltage on the external electrodes 40, 42. The passage of the particle also results in a measurable change in signal at the optrodes within the aperture. The aspirated particle generates a pulse, detected as a change in the current or voltage at the external or optrodes, as they traverse the aperture. The signal at the optrodes in conjunction with the signal at the external electrodes is analyzed to get detailed information on the particles. Optionally, optrodes 46, 48, 50, 52 may be sandwiched between two insulating or semi-conducting substrates having a through aperture 62 and placed around the circumference of the aperture 62.

The fluid sample of known dilution is placed in an apparatus suitable for carrying out the necessary measurements as is well known in the prior art. The fluid can be made to move through the aperture using any method well known in the prior art using positive or negative pressure. For hydro-dynamically focusing the particles, any suitable mechanism well known in the prior art can be employed.

The pressure differential across the transducer can be reduced to decrease the speed of the particle. By making the pressure differential negligible, the particle can be confined to the constricted electrical path, thus enabling detailed measurement on the particle. Confining the particle in the constricted path could be very useful in case of impedance computer tomography measurements. The particles can also be moved using other mechanisms like an influence of an electric field. The particles might be propelled through the apertures by electrophoretic or electro-osmotic potentials instead, or along with, the trans-membrane pressure difference. Electrophoretic mobility of charged particles can be used for selective movement of particles. The additional information gained in this manner, when combined with the size measurement, would be of value in the study of colloids particularly related with zeta potential.

There are several possible methods to manufacture electrodes on the transducer. In one method of manufacture, holes may be drilled through gold foil tracks on an epoxy resin sandwiched between two thin sheets of glass, using a small, e.g., 350 micron, drill. However, such techniques may not be feasible to produce smaller apertures. One method to form membranes having suitably sized apertures is to prepare optrodes 46, 48, 50, 52 and connecting wires 54, 56, 58, 60 on the surface of a thin glass sheet. This can be done by using electron beam lithography. A coating of an etchable polymer like polyamide is laid over the thin glass sheet. Through the etchable polymer, the first portion of the pores is made, again preferably by electron beam lithography, and finally to etch connecting channels through the glass sheet to form the second portion.

Substrate material could be any advanced ceramic material like high quality alumina, silicon, quartz, sapphire, glass, or kapton. However, other substrate material may also be suitable provided that it has adequate insulation properties, mechanical strength, flatness, suitability for certain manufacturing processes, and ion penetration characteristics. Using standard techniques like sputtering and vapor deposition a thin layer of metal can be fabricated. To increase the thickness of the metal deposition standard processes like electroplating can be used. A suitable electrode pattern can be created using standard lithography. However, it is recognized that other processes may be used such that they provide the proper shape and size tolerances. Preferred electrode materials include chromegold, nickel, titanium, and platinum.

Hole drilling can be done using techniques like laser or ultrasonic drilling, dry or wet etching, ion-beam milling or a combination thereof. In a preferred embodiment, the device may be produced by a combination of photo or electron-beam lithography and ion-beam machining. Other processes may also be suitable provided that they result in the desired smoothness, taper or lack of taper, and physical tolerances. This is done on any substrate suitable for the manufacture of semiconductor devices, for example silicon. This is followed by deposition of an inert insulating layer of a suitable substance, for example silicon dioxide. In this case the conductive output leads and optrodes can be made by techniques similar to those used in the manufacture of integrated circuits. An advantage of this method of production is that active semiconductor circuitry such as amplifiers and logic gates may be placed directly on the device to perform some pre-processing of the signal.

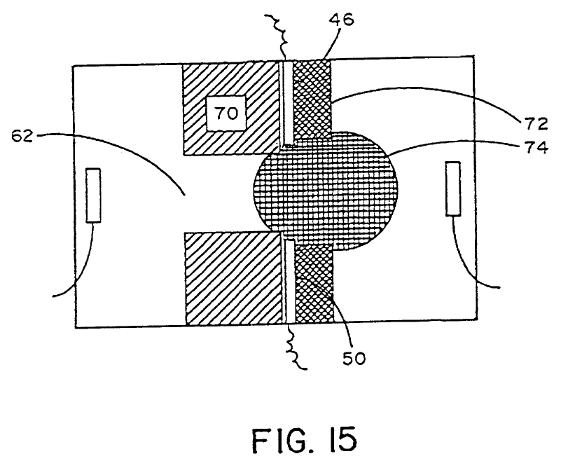

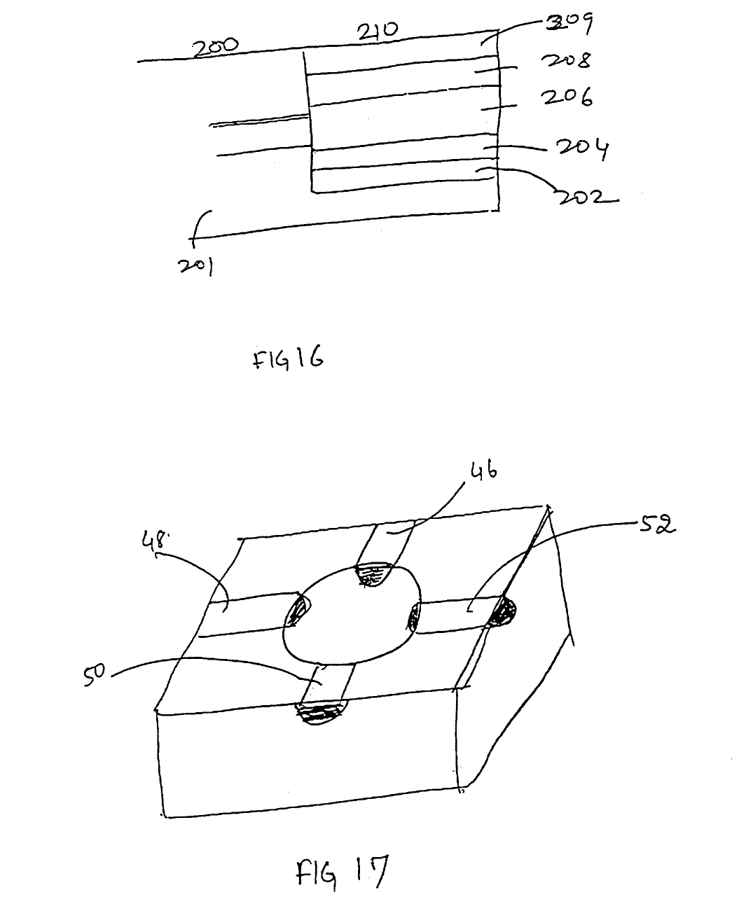

FIG. 15 is a sectional view of an alternative transducer embodiment with one side of the optrode being covered by an insulator coating. In this embodiment a set of optrodes 46, 50 are fabricated on a substrate 70 at the end of the aperture 62 and then given an insulator coating 72. This is advantageous as it facilitates fabrication because the optrodes can be made using any standard technique of lithography. The insulator can be patterned using lithography techniques by exposing from either side of the aperture or by simply spin coating or can be applied using a brush. Insulator coating 72 need not cover the electrode all the way up to the aperture. The sensing zone 74 might spread outside the aperture and may be asymmetrical and non-uniform, however, this is acceptable for certain applications. For example, in case of counting particles, this does not introduce any significant errors. Preferred insulating materials include oxides, nitrides, epoxy, polyamide, and glass, and suitable application techniques, e.g., dipping, painting spraying, and electrobonding, depend upon the material chosen.

FIG. 12 is a sectional view of an alternative embodiment of the transducer where optrodes are formed by supplemental apertures 106, 108 along the plane perpendicular to the axis of the main aperture 62, and each having an optrode (electrode or optode) 102, 104 similar to external optrodes. These apertures function similar to the planar optrodes described earlier that were located on or immediately adjacent the aperture wall. The obvious advantage of this type of electrode is that it avoids the problems of polarization of electrodes, where the quantity and the time duration of the application of current through an electrode can damage the electrode. The diameter of these planar apertures is preferably smaller than the diameter of the main aperture. The loss of radiation at the interface between the fluid and the optode in the earlier described embodiments can be greatly reduced. These aperture type optrodes 102, 104 can be made using any combination of the techniques mentioned earlier.

Signal generating circuitry 51 takes inputs from various systems to establish the constricted electrical and optical path. Signal generating circuitry 51 comprises multi-frequency current sources, multi-frequency voltage sources, light sources, laser sources and a system for feeding the signal to active optrodes in various combinations comprising multiplexers, demultiplexers, amplifiers, digital-to-analog converters and lenses. Circuitry for measuring the change in voltage across or current through passive optrodes includes high pass filters, low-pass filters, demultiplexers, amplifiers, sample and hold, peak detectors, comparators, monostable multivibrators, lock-in-amplifiers, trans-conductance amplifiers, isolation amplifiers, opto-couplers, analog-to-digital converters, frequency modulators and amplitude modulators.

The circuitry may include preamplifier which contains a low-noise programmable constant current source. This constant current is divided between two paths. One current path flows through the electrodes in the impedance transducer; the other flows into the preamplifier. Since the sum of both currents is constant, a change in the current through the electrodes (caused by cell passage through the impedance transducer) is reflected as a change in the output voltage of the preamplifier. The output from the impedance transducer preamplifier can be routed to two independent paths, each having a 12-bit programmable gain, baseline restorer, pulse detector, and peak hold circuit. A pulse is detected as valid if its peak value exceeds a given threshold. The data acquisition subsystem recognizes level thresholds and slope thresholds. The slope threshold improves the hardware counter dead time by allowing the counting of two pulses that arrive very close in time. Each type of cell requires its own qualification criteria. RBC pulses should exceed a certain level and slope. A certain negative slope should be exceeded in order to reset the detector for the next pulse.

PLT pulses occur in the same sequence with RBC pulses. However, PLTs are distinguishable from RBCs because PLTs are smaller. A pulse is classified as a detected PLT if it exceeds a lower level threshold but does not go above an upper threshold. Additionally, the pulse must exceed a predetermined positive slope in order to be considered a valid PLT. A certain negative slope should be exceeded in order to reset the detector for the next pulse. If a pulse satisfies the qualification criteria, a trigger signal is sent to the peak-hold circuit, and subsequent ADC conversion is initiated. Trigger pulses from the impedance transducer are counted in two dedicated 16-bit counters. One counter is for RBCs, and the other counter is for PLTs. Each output path from the impedance transducer preamplifiers includes a baseline restoration circuit to subtract the background DC component from the amplified signals. The offset voltage created by these circuits is monitored, thus providing a tool for diagnostics.

Light emitted from the optical flowcell is collected at different angles by the detectors, which include photodiodes (PD1 and PD2) and photomultipliers (PMT1, PMT2, and PMT3). These signals have a wide dynamic range, and accordingly a wide range of gain adjustment is provided. For the PMTs, gain adjustment is preferably accomplished by controlling a dynode voltage on the PMT itself (about 200 V to about 1100 V). The optical preamplifiers of the PMTs convert the current output from the PMTs to a voltage with fixed gain. The optical preamplifier outputs are routed to independent paths or channels. Each channel include its own baseline restorer, pulse detector, peak hold circuit, and 12-bit programmable gain (post peak-capture). An “optical” pulse is detected as valid if its peak value exceeds a predetermined programmable threshold. A valid pulse generates a digital trigger pulse. The trigger pulse can be programmed to be one of several selected logical combinations of channels (PD1, PD2, PMT1, PMT2, PMT3). Each channel has its own programmable lower threshold. The trigger pulse initiates the peak-capture and subsequent ADC conversion of the captured peak values for each of the channels. The trigger may be qualified by requiring a gating criteria. For example, the trigger may be invalidated if the signal on PD1, PD2, or PMT2 exceeds a predetermined gate threshold. A baseline restorer circuit is provided for subtracting the DC component from the pulse signals, thereby reducing any DC background offsets. The response time of these circuits is slower than the width of the average pulse. The offset voltage created by these circuits is monitored, providing a tool for diagnostics.

The high-pass filter eliminates the impact of random changes in the voltage at the electrode-electrolyte interface that normally changes very slowly. The random drift in the electrode-electrolyte impedance arises due to the complex processes occurring at the electrode-electrolyte interface and the change in the composition of the electrolyte itself as the electrolyte moves over the electrode. In general, measurements of impedance are performed by connecting low impedance electrodes to a conductive region and driving a current between them. The resulting voltage is measured with a suitable voltmeter. To eliminate the error due to the measurements, it is usual to employ a second receiving pair of electrodes to measure the voltage. Provided that the input impedance of the voltmeter is much higher than the electrode impedance, the voltage measured per unit current through the driving electrodes is little affected by any of the four electrode impedances or fluctuations thereof. Inter-electrode capacitance and leakage capacitance that determine the noise levels and the frequency response of the transducer can be easily estimated by known methods. The ratio of the width of the pulse to the peak height of the pulse is a good measure of the gross shape of the cell. The integrated area under the pulse is a good measure of cell volume and is relatively independent of the cell shape. Circuitry for analyzing the change in the electrical characteristics of the particles may include systems for counting, measuring, differentiating, separating, controlling, impedance computer tomography, signal-correlation, coincidence error, off-axis particles, velocity measurement, controlling pressure, and electric and magnetic fields within the transducer. A system basically comprises of an algorithm implemented through known hardware and/or software. The various systems take inputs from each other depending on the particular application. The exact nature of combining these systems depends on the particles to be distinguished, the nature of the fluid, and the size of constricted electrical path. Signal generating circuitry 51 also takes inputs from various systems to establish the constricted path that is most applicable for the particular measurement.

All the data is compiled and subjected to statistical analysis and techniques like curving fitting and clustering analysis. A signal from the second stage of amplification or directly after the input stage of amplification goes to the threshold detector. The electrodes are connected to the data-acquisition system by short-lengths of co-axial cable to reduce the effect of extraneous noise and interference. The signal source should be placed as close to the electrodes as possible. The outer sheath of the co-axial cable is coupled to the feedback path of a voltage buffer to provide further noise immunity and the inner core is capacititively coupled to the input of the voltage buffer. This invention overcomes many drawbacks suffered by the prior art designs. For example, the present invention is not significantly affected by activity that would cause extended sensing zone errors in other designs because the optrodes are spaced sufficiently away from the end of the aperture, causing the significant portion of the electric field to be restricted in the aperture itself without spreading outside the aperture. Therefore, the presence of a particle outside the aperture has no significant influence on the measurement. As shown in the FIG. 9, the substrate 66 restricts the electric field to a narrow volume within the aperture. It is desirable to have the diameter of the aperture as narrow as possible so that the influence of a single particle can be detected.

The invention allows for the use of a desirable long aperture therewith because the electrodes are disposed inside the aperture walls and are be positioned quite close together. Such was not possible with other prior art apertures having external electrodes, because the longer the aperture was, the wider the pulse produced. So if a long aperture was used to get good flow characteristics, it also broadened the pulse width, thereby decreasing the counting rate attainable. A long aperture is desirable because it smoothes out turbulence and other non-linearity affecting the cell movements before readings are taken. In hitherto known apparatuses for the analysis of blood samples the recirculated erythrocytes generate weak measuring signals which are approximately of the order of magnitude of the signals which normally are produced by the much smaller thrombocytes. With the proposed method and the proposed apparatus the recirculated erythrocytes do not produce any disturbance or interference signals, so that it is thus possible to count and to measure the erythrocytes and thrombocytes in the same sample. Thus the need for lysis of the erythrocytes is eliminated, thereby making the sample preparation quicker, simpler and less expensive.

With the use of multiple optrodes, detailed information on the shape of the particles can be obtained. As such there is no restriction on the number of optrodes that can be employed for sensing the particle. Thus, arrangements of 2, 3, 4, 6, 8, 12, and 16 optrodes in a single plane is possible and more advantageously with multiple pairs of optrodes. Moreover, these configurations can be repeated along the length of the aperture as described further herein.

The signal obtained at the measuring optrodes is fed to the image reconstruction system that is used for forming an image of the particle. Implementing an adaptive process to produce the best currents to distinguish the unknown conductivity from a homogeneous conductivity can enhance accuracy of the system. The ease with which electric currents can be switched from electrode to electrode, and the ease with which the voltages can be measured, gives impedance imaging certain advantages and practical attributes. These attributes include: high-speed data acquisition, minimal electronics, low cost and portability.

For the given dimensions of the transducer and for a given kind of particle suspended in a fluid, the best currents for establishing the constricted path are calculated. These given values of currents are fed through active electrodes to form a constricted electrical path. The passive electrodes measure the change in current or voltage. These measurements serve as inputs to image reconstruction system or impedance tomography system. Tomography algorithms converge very fast if the initial value can be estimated reasonably accurately. Initial estimates can be obtained from the measurements at the external electrodes. Reasonably fast and good estimates of the particle shape can be obtained this way. Additionally, some prior designs have assumed a “shape factor” to reduce orientation errors and to compensate for their inability to get accurate readings. For instance, if an extremely elongated particle is assigned a shape factor of 1.0, then the spherical particle of the same volume has a shape factor of 1.5. However, merely assuming a shape factor can lead to inaccuracies that may be significant. Moreover, these inaccuracies may be exaggerated due to the relative deformability of the particles. Thus, the ability of the current invention to obtain readings from plural transverse angles across the flow aperture can help to rectify this problem.

In another embodiment of the invention, the cross-sectional position of the particle in the hole of the transducer is determined. It includes systems for distinguishing between a particle moving in the center of the hole and a particle moving close to the wall of the hole. Process tomography provides real-time cross-sectional images of the distribution of materials in a process. By analyzing two suitably spaced images, it is possible to measure the direction and speed of material movement. It is possible to distinguish between the particles that are traveling in the center and those which are traveling near the walls of the aperture. This knowledge is used to correct the size obtained using the voltages measured at the external electrodes by applying corrections well known in the art. Impedance measurement can also be done using all the optrodes of one plane in passive mode. When the particle traverses the aperture, it creates a bi-phasic pulse on the passive optrodes. When the particle is present inside the aperture the resistance of the zone between the optrodes and the external electrode, from which side the particle has entered, is increased. This leads to the change in the voltage of the optrodes. The resistance between the optrode and the other external electrode increases when the particle crosses the optrode. This again alters the voltage on the optrodes. This data is fed into the impedance tomography algorithm to get information on the particle conductivity or particle size or particle shape or particle position or a combination thereof.

An iterative approach to the calculation of these parameters would give the best results. Using any of the standard techniques well known in the art can make the starting point estimates. The pulse height and the pulse duration are the two important parameters for using fast algorithms. More detailed information can be obtained by applying standard techniques of signal processing like integrating and differentiating the pulse. The second way to improve the accuracy of the measurement is to examine the shape of the (normally bi-phasic) output signal. A mismatch between the shape and amplitude of the positive and negative phases for each particle passage, or an incorrect time relationship between the two phases indicates a spurious event. This could be a coincidence or a noise spike and is rejected. Finally, for each pulse, the two phases may be averaged, further reducing the noise.

As is appreciated in the art of cytology, any new particle descriptor that can be measured is useful in identifying, analyzing and sorting particles. For example, cells have a membrane of very high resistivity which is in the range of a dielectric. However, the internal portion of the cell is fairly conductive, with different types of particles having varying internal resistivity. Also, it is contemplated that the pathological state of the cell will affect its internal resistivity. Consequently, it is desired to measure this internal resistivity on a cell-by-cell basis. The high frequency source, which has a frequency in the radio spectrum or even higher, provides a signal through the orifice simultaneously with the low frequency source. The two sources produce identifiable signals capable of separate detection when the particle moves through the orifice, one signal being a low frequency (L.F.) signal which is due almost completely to the size of the particles, and the other being a radio frequency (R.F.) signal (being defined as above 1 MHZ) which is due not only to the size, but to the combined effects of size, shape, resistivity and reactance. These output signals are applied by the external electrodes and to a conventional detecting means. The low frequency detector includes a low-pass filter, for preventing the R.F signals from saturating the circuit. If the low frequency is not zero, then demodulating circuitry is included. The R.F. detector includes amplitude modulation detection means for demodulating the R.F. signal.

Multiple optrodes can be employed for making measurements at multiple frequencies. Because of the planar structure of the optrodes, the inter-electrode capacitance and stray capacitance is significantly lower than that for the optrodes. By connecting different frequency sources to different pair of electrodes, interference between the frequency sources can be reduced. Multiple electrodes can also be employed for imaging the permittivity of the particle. Independent information in the impedance data due to the permittivity enhances the instrument's ability to distinguish objects with different interior structure. With the accurate shape and volume measurements, a precise determination of a particle's resistivity can be extracted from the internal resistance measurement. A precise determination of a particle's resistivity can be extracted from the internal resistance measurements inherent in the R.F. signal. The determination of a particle's resistivity on a particle by particle basis is of great value as a new descriptor for analyzing and identifying biological cells. In the prior art devices, it was possible to use the R.F. signal to measure the particle's internal resistance, but this measurement has no meaning by itself. This is due to the fact that internal resistance measurement varies not only with the particle's internal resistivity, but also with the size, the shape, and the orientation of the particle. Likewise, in the prior art devices, it was possible to use the first and second impedance signals to measure the particle's opacity, but this measurement varies substantially with the shape, the orientation and the internal resistivity of the particle.

FIG. 19 is a sectional view of an alternative embodiment of the transducer with multiple sets of optrodes arrayed along the axis of the aperture. Multiple electrodes 46, 50 of the first set of optrodes create a constricted path 64 and second set of optrodes 78, 80 create a downstream second constricted path 82. Depending on the application and method of production the substrates 66, 68, 76 could be same or different. By keeping a sufficient distance, usually equal to few times the aperture diameter between the two sets of optrodes, the two constricted electrical paths can be electrically independent of each other. This establishes two constricted electrical paths in succession. Signals obtained from each constricted electrical paths are correlated to improve the signal to noise ratio of the transducer. Signals obtained from the optrode arrays are correlated with signals from the external electrodes to further improve the signal to noise ratio. In another embodiment of the invention, the velocity of the particle while moving in the hole of the transducer is determined. The signal analysis circuitry includes system for calculating the velocity of the particle. Signal correlation circuitry measures the exact time the particle has taken in moving from one constricted path to the second constricted electrical path. Accurate measurement of the velocity of the particle is made possible because of multiple constricted electrical paths. For example, let T be the time required to travel from upstream-constricted path to the downstream-constricted electrical path. This time can be measured much more accurately as explained below. The time delay of the fluid is obtained by multiplying the output of downstream-constricted path by a time-delayed version of the output of upstream-constricted electrical path. The time-delay is adjustable. The product of the two signals is then integrated over a period of time to give the mean value that is called the cross-correlation function. When delta T and the adjustable time delay are unequal, the mean value of the product is small. Only when the fluid time delay and the cross-correlation time delay are equal does the mean value of the product of the signals reach the maximum value. The time delay of the maximum value of the cross correlation function uniquely defines the transit time of particle between the two constricted electrical paths. Dividing the distance between the two constricted electrical paths by the transit time as obtained above, gives the value of the velocity of the particle.

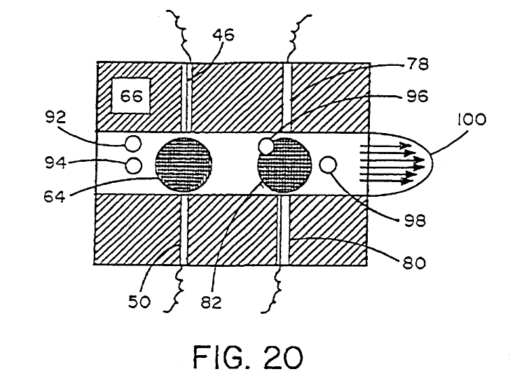

FIG. 20 is a sectional view of the transducer showing two particles 92, 94 entering the aperture simultaneously and being separated in space as they emerge at the end of the aperture because of radial components of velocity. This embodiment of the invention is used for reducing the coincidence error. This is made possible by comparing the signals obtained from multiple constricted electrical paths. Let two particles 92 and 94, enter the constricted path 64 simultaneously. Let particle 92 be away from the axis and particle 94 be close to the axis. Laminar fluid flow through a circular tube normally follows a radially varying velocity profile (parabolic in the fully-developed channel-flow and flattened, but still reduced at the edges due to growing boundary layers, in a short entrance region) velocity profile 100, wherein the fluid in the center moves faster than the fluid in the periphery. Because of this, particles 92 and 94, which entered the aperture together, are separated in space by the time they reach the second constricted path 82 and have been illustrated as 96 and 98. The simultaneous presence of both the particles in the constricted path of electrode 46 and 50, results in the signal that is due to the combined effect of both the particles. Particle 94 enters the second constricted path 82 after T1, followed by particle 94 after T2 that causes a separate voltage peak. For an abnormally large peak, the signal from the two constricted electrical paths would be analyzed to ascertain if it had arisen because of multiple particles in a constricted electrical path.

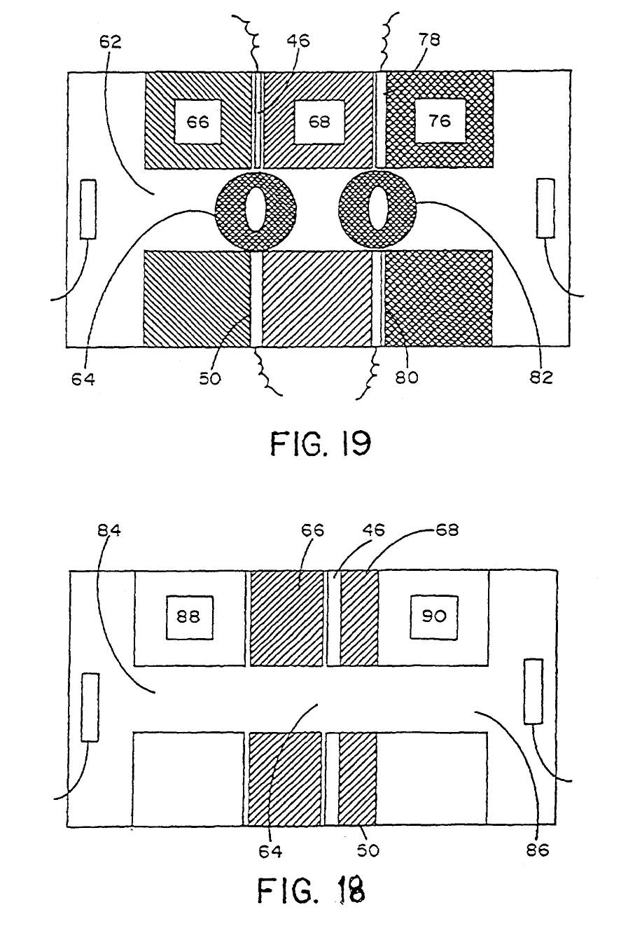

FIG. 18 is a sectional view of an alternative embodiment of the transducer with electrodes for focusing the field of the optrode array. Optrodes 46, 50 are sandwiched between insulating materials 66, 68. Metal electrodes 88, 89, 90, 91 with a shape identical to the optrodes 46, 50 are embedded in the insulating layer close to the plane of the optrodes. The thickness of the electrodes is kept sufficiently large and their function is to focus the field of the optrodes 46, 50 in the plane of the optrodes. Field lines 84 due to focusing electrodes 88, 89 and field lines 86 due to focusing electrodes prevent the field of the optrodes from spreading along the axis. Field focusing of the type mentioned above is fairly well known in the art and has significant benefits. By using field focusing the field is restricted to a narrow region thereby intrinsically reducing the probability of co-incidence error. Hence much faster flow can be accepted.

In another embodiment of the invention, the apparatus further comprises a system for controlling the magnetic field in the transducer to control the movement of the particle, which is magnetically susceptible. Magnetic forces are used for enhancing the efficiency of chemical and biochemical separation processes. The imposition of an external and controllable magnetic field is used to influence the motion of magnetically susceptible species. The species of interest are rarely naturally magnetic. Therefore it is necessary to impart appropriate properties to the desired species. Magnetic Carrier Technology involves the labeling of a macromolecule with a magnetic tag, or attachment of the species itself to a larger magnetic carrier. Many of the enzymes can be immobilized over magnetic fluidized beds. Traditionally, large-scale industrial biochemical processes use either soluble enzymes or finely divided monocultures of cells to convert a substrate into product. The small size of the biocatalyst presents a major disadvantage in that it is almost impossible to operate such systems continuously. Any throughput of the substrate solution inevitably results in an outflow of the active biocatalyst, resulting in losses. In the case of a homogeneous, soluble enzyme, this loss of biocatalyst also results in the contamination of the product liquor with active proteins that often requires removal or deactivation. Thus the use of free enzymes and cells is, currently, almost exclusively limited to batch operations.

In this embodiment of the invention, the biocatalyst is tagged on to a magnetic carrier that can be easily trapped in the transducer. This can be done by either controlling the electromagnetic field in the transducer or by controlling the pressure differential across the transducer. The particles carrying the biocatalyst are moved into the reaction zone and can be called back into the transducer by reversing the pressure differential. In another embodiment of the invention, the apparatus comprises multiple holes on the transducer, wherein each constricted path provided thereby includes corresponding elements and behaves like the apertures shown in any of the previous figures. Moreover, each includes an electrical path connected to individual or common signal generating and signal analysis circuitry. This way the transducer acts as an active filter.

In another embodiment of the invention, a part of the signal generating and signal analysis circuitry is made on the transducer itself. On-chip signal generating and signal analysis circuitry includes input pre-amplifiers, a multiplexers, shift registers, test-wave generator and the like. These components are fabricated on the semi-conducting substrate through which the thin hole of the transducer has been drilled, to eliminate the cross talk and stray noise pick-ups. On-chip self test circuitry for testing electrode impedance level can also be provided. On-chip circuitry reduces the number of output leads, thus reducing chip size and the tethering effect of these leads on the probe structure. Secondly, the signal amplification and multiplexing boost the signal levels. This makes the overall system less prone to noise.

Additionally, signal buffering reduces the output lead impedance, reducing encapsulation problems. For example, the on-chip signal generating and signal analysis circuitry comprises input pre-amplifiers, analog switches, shift registers, two-phase clock, high speed output buffer, power-on reset, test enable latch, test waveform generator, which has a voltage divider and a 4-stage counter. The power supply for the circuitry is designed to have a fast turn-on time (i.e., 0 to 5 V in 200 ns) so that on-chip electronics can be used to reset the shift register. High input impedance amplifiers placed in close proximity to the optrodes would minimize the current drawn from these electrodes and consequently reduce the risk of polarization. Because of the possibility of on-chip circuit analysis, the particles can be identified much more accurately and large number of particles can be separated. However, it should be noted that this system could be used with any known system for separating particles.

Graham in U.S. Pat. No. 6,111,398 describes an apparatus for sensing and characterizing particles wherein the interior wall of the conduit effectively varies in resistivity along the length of the conduit to define a delimited central region of high electrical resistivity, which is smoothly contiguous on its opposing boundaries to uninsulated distal elements of lesser electrical resistivity. The delimited central region of the conduit functions as a Coulter volumeter conduit. The uninsulated distal elements of the conduit are made to have a dimension along the conduit wall which is at least equal to the axial extent of the effective ambit electric fields of a traditional Coulter volumeter conduit having a cross-sectional geometry identical to that of the delimited central region of high resistivity in the improved volumeter conduit.

According to a preferred embodiment of the invention, the delimited central region of the improved volumeter conduit is defined by a traditional Coulter conduit wafer, i.e., a dielectric wafer containing a central circular conduit, and the distal elements of lesser resistivity are defined by uninsulated, electrically conductive, circular collars attached to opposite sides of the conduit wafer. The conduit in the conduit wafer and the openings in the conductive collars collectively form a hydrodynamically smooth volumeter conduit, in which the electric and hydrodynamic fields of the traditional volumeter conduit are advantageously amended in the manner above noted. Combining the above geometry with the present invention can lead to significant benefits.

In another embodiment of the invention, the apparatus is used for separating different particles. The aperture is connected to a droplet-emitting nozzle that has a conducting fluid (sheath) flowing into it through a narrow tube under high pressure. The nozzle is designed to establish laminar flow conditions which provide for more predictable and stable particle trajectories through the channel and also increase the likelihood the sample will be centered in the stream. The fluid carrying the particle along with the sheath is ejected as a minute droplet. The droplets are charged and fall under gravitational force.

Along the path of the droplets the two metal plates connected to signal generating and signal analysis circuitry through connecting wires establish a controllable electric field. After passing through the electric field, the droplets break-up into separate streams and are finally collected in appropriate containers. Because of the possibility of on-chip circuit analysis, the particles can be identified much more speedily and accurately and as a result large number of particles can be separated. In another embodiment of the invention, the apparatus distinguishes between signals arising due to the passage of different kinds of particles through the transducer. Circuitry for distinguishing particles takes input from measuring electrodes, means for signal correlation, means for impedance computer tomography, means for shape analysis, means for velocity measurement, means for identifying off-axis particles and means for eliminating co-incidence error. The exact nature of combining these means would depend on the particles to be distinguished, the nature of the fluid and the size of constricted electrical path. Clearly, signal generator and signal analysis circuitry for the several kinds of transducers mentioned above would clearly depend on the specific use of the apparatus and the level of accuracy desired.

In one embodiment of the invention, the signal at the external electrode is sampled after a fixed delay after the particle has traversed the plane of the optrodes. If all the optrodes are in the passive a mode the point of crossing of the plane of the optrodes is the point at which the bi-phasic signal crosses the zero line. If the optrodes establish a constricted electrical path, the point of crossing of the plane of the optrodes is the point at which the peak occurs at the optrodes. It should be apparent that the signal on the external electrodes would be sampled only if the optrodes register a particle, and not then when the particle is recirculated due to turbulence.

Additionally, there are locations of the channel where the boundary or fringe effect of the measuring field is not effective, i.e., when the particle is momentarily disposed at such a location that the instantaneous or momentary measuring value is practically dependent only upon the particle size and not upon the path of travel of the particle. The sampling operation can be triggered at that point in time when the particle is disposed at such an advantageous location so that the sampling value also is not disturbed by the boundary effects of the measuring field.

Sensors including temperature sensors, pH sensors, conductivity sensors may be used for monitoring the physiochemical environment in the constricted path.

As known in the art, the pH sensor can be constructed by deposition of a metal electrode (such as an iridium electrode) whose electrical potential varies with changes in pH. The inclusion of an integrated pH sensor helps in providing a closed loop feedback and monitoring at multiple locations in constricted path.

The temperature sensor can also be fabricated conveniently in accordance with standard micro fabrication techniques. For example, layers of different metals may be deposited to form a thermocouple junction or the TCR of the thin film heater could be used directly to monitor temperature. The output from this sensor could then be used via suitable external (or on-chip) circuits to selectively activate the temperature-controlled bath that consists of integrated or non-integrated heating or cooling elements. Additionally, the integrated temperature sensor referred to above may advantageously provide closed loop temperature control, particularly when used in conjunction with the integrated sections of flow control.

The conductivity sensor can also be fabricated conveniently in accordance with standard micro fabrication techniques thereby providing closed loop feedback. As will be obvious to one of ordinary skill in the art, other sensors depending on the property to be measured can be integrated to provide closed loop feedback.

A further feature of preferred embodiments of this invention is the use of apparatus made of transparent materials. This enables the user to observe cell interiors and the processes of micro diffusion and microelectroporation through a microscope as they occur.

To preserve the viability of the desired target cells, the carrying fluids in which the biological cells are suspended are typically buffered saline solutions having, in some embodiments, a standard physiological osmolality (e.g. 275-300 mOs/kg-water for most mammalian cells), and a pH in the physiological range (e.g. about 7.0-7.6 for most mammalian cells). The ionic strength of the solutions in certain embodiments is essentially the same as the ionic strength of the intracellular fluid (e.g. about 0.15 M NaCl equivalent for most mammalian cells).

The solutions that are used for electroporating red blood cells are resistance-enhancing fluids. It is important to note that the IHP solution should have a high resistivity and should have a minimum of electrolytes. The IHP from Aldrich Chemical Company or from Matrea Chemical Company does not contain any sodium chloride and a minimum of other electrolytes. The milliosmolarity of the solution should be between approximately 300 and 500. The resistivity should be between approximately 87 ζ-cm and 185 ζ-cm. The conductivity should be between approximately 4 to 8 nS/cm. The practical salinity should be between approximately 4 and 9 ppt and the NaCl equivalent should be between approximately 4.5 and 9.0 ppt.

Cell stressing means stress the cell membrane to enable exchange of material and can be carried out in multiple ways by subjecting cells to electromagnetic radiation and electromagnetic field.

In another embodiment of the invention, the apparatus to address this problem further comprises means for generating a constricted path with a very strong electrical field gradient. In one of the embodiments, the electric field is established by optrodes in the downstream. The electric field establishes the critical trans-membrane potential and causes partial and temporary breakdown of cell-membrane. The electric field can be easily controlled so that only a little area of the membrane is broken. When the particle passes through the upstream constricted path, it is identified and the electric field may be established selectively for a certain kind of particles. The electric field may be either a high frequency signal or a high voltage spike.

The advantage of using optrodes is that not only can the field intensity be controlled but also the direction of the electric field. Thus the shape of the particle and its orientation can be established using the sizing algorithm and, depending on these values, the particle can be subjected to a controlled field for a controlled duration. The above embodiment can be used for determining the dielectric breakdown characteristics of electrolyte-suspended particles having membranes, especially organic cells derived from living organisms, especially liposomes, protoplasts, chloroplasts, vacuole cells or the like and for determining the size of the particles and other characteristics thereof subsequent to dielectric breakdown. Further, electroporation may be accomplished by passing the particles continuously through a measuring opening and each time, while they traverse the opening and are in movement therethrough, subjecting the particles to a linearly increasing electric field (rising, say, to 100 volts) and, from the speed of the particles with respect to the length of the measuring opening or orifice, the electric field and the change in the current through the orifice, determining the dielectric breakdown of the particles, the field strength being sufficient to effect such breakdown. The increase in the current traversing the measuring opening, while a particle is passing therethrough, deviates from linearity and the resulting change in current, by comparison with the linear increase in current through a reference passage not traversed by the particles is an indication of the size of the particle prior to dielectric breakdown and the apparent size of the particle subsequent to dielectric breakdown.

As the particle traverses the sensing zone the electrodes are energized by a voltage which is increased until dielectric breakdown occurs and the change in the current passing between these electrodes is measured. One of the main limitations of this technique is the lack of control on the orientation of the electric field.

Electroporation field can be created in multiple ways including as a continuous field, pulse field, can be triggered only when the cells are present or as a bipolar field. Separate electrodes can establish the measurement field and electroporation field.

Phototherapy:

It is well known that porphyrins and many other photosensitizing compounds induce cytotoxic effects on cells and tissues. These effects are based upon the fact that the photosensitizing compound upon light exposure releases ¹O₂ that decomposes the membranes of the cells and cell structures and eventually kill the cells if the destruction is extensive. These effects have been utilized to treat several types of neoplastic diseases. The treatment is named photodynamic therapy (PDT) and is based on injection of a photosensitizing and tumor localizing dye followed by exposure of the tumor region to light. The cytotoxic effect is mediated mainly through the formation of singlet oxygen. This reactive intermediate has a very short lifetime in cells (<0.04 micro seconds). Thus, the primary cytotoxic effect of PDT is executed during light exposure and very close to the sites of formation of ¹O₂. ¹O₂ reacts with and oxidize proteins (histidine, tryptophan, methionine, cysteine, tyrosine), DNA (guanine), unsaturated fatty acids and cholesterol.

One of the advantages of PDT is that tissues unexposed to light will not be affected. There is extensive documentation regarding use of PDT to destroy unwanted cell population, for example neoplastic cells. Several patents relate to photodynamic compounds alone or conjugated with immunoglobulins directed to neoplastic cell receptor determinants making the complex more cell specific. Certain photochemical compounds, such as hematoporphyrin derivates have furthermore an inherent ability to concentrate in malign cells. In some cases an anticancer drug and a photoactivatable drug is attached to copolymeric carriers. Upon administration this complex enters the cell interior by pinocytosis or phagocytosis and will be located inside the endosomes and lysosomes. In the lysosomes the bond between the antineoplastic compound and the polymer is hydrolyzed and the former can diffuse passively through the lysosome membrane into cytosol. Thus this method limits the method to small molecular compounds, which are able to diffuse across the lysosome membranes. After allowing a time lag for diffusion a light source of appropriate wavelength and energy is applied to activate the photoactivatable compound. The combined effect of the anticancer drug and photoactivatable drug destroy the cell. Thus photoactivatable compounds can be used to destroy cell structures leading to cell death.

Depending on the measurement of cells, cells can be selectively destroyed when used in a single-cell-flow system. It can be used for applications other than for destroying cells.

Electromagnetic Waves-Laser:

Neuberger in U.S. Pat. No. 6,343,174 describes a laser delivery system that incorporates fluid delivery channels within the optical fiber structure so as to bring fluids directly to the site of laser power delivery. The channel or channels may pass through either the fiber core or the cladding. The fluids delivered to the site may serve to cool or irrigate the tissue during high power laser treatment. In addition, the fluid passed through the channel can be a drug or any substance that increases the tissue's photosensitivity to the laser energy.

Gregory in U.S. Pat. No. 5,836,940 describes a liquid core laser catheter that can be very effectively combined with the present invention. In one of the embodiments, the laser light is used to create rapid displacement of the flowing liquid thereby producing a hydraulic or pressure wave that drives the active agent into the cells.

Elstrom in U.S. Pat. No. 5,999,847 describes an apparatus in which transient pressure waves are created by converting light into acoustic energy. The pressure gradients affecting cell membranes are produced in a controlled manner by manipulating the characteristic of the light energy deposition process into the constricted path. The process of thermal elastic expansion in the coupling interface material governs the conversion of light energy into mechanical waves. When light energy is applied in a brief manner to a material or medium, heat is generated which is converted into acoustic waves as the energy is dissipated to the surrounding medium. Stress generation is governed by the thermal diffusion and the speed of sound of a material or medium. Depending on the time duration of a pulse of light, high stress or pressure can be generated in a medium. For effective delivery, light of sufficient energy is applied so as to not create pressure waves sufficient to permanently damage or lyse the cells.

Stress generation by confinement is the preferred method of production due to its relatively small increase in temperature. The laser pulse heats the coupling interface medium much faster than the time required for the stress waves to propagate through the irradiated volume. A dimensionless parameter of stress confinement is the product of the optical absorption coefficient, the speed of sound, and the laser pulse duration. This parameter can be used to determine the degree of confinement. The energy per area of a light pulse and its repetition rate can be used to create a stress gradient within a specific region of tissue as the mechanical waves travel from the irradiated spot.

In addition to the creation of the transient poration of cell membranes, the propagating acoustic waves, which have very high frequencies, create micro streaming motions within regions containing liquid such as extracellular space of tissue and intracellular space of cells. Since micro streaming is proportional to acoustic absorption, the high frequencies can promote effective micro streaming forces due to rapid attenuation of the propagating wave. The micro streaming forces can result in circular motion of the extracellular liquid and the cell cytoplasm. This motive action can enhance transport of the delivered agents into the intracellular space as well as toward the nucleus of the cell. Microstreaming increases the probability of the agents to be transported into nucleus of the cell.

One mode of practice of confined stress generation of acoustic waves is the use of a Nd:YAG laser operating in a Q-switched mode (Model YG 681, Quantel International, Santa Clara, Calif.). Short laser pulses, with duration of nanoseconds to microseconds, can be applied to a localized area. In some applications, the coupling interface can be used to generate the stress gradient within the coupling interface. The stress gradient then propagates into the underlying constricted path. The coupling medium serves to enhance coupling of the acoustic waves into the underlying constricted path. The coupling medium can be a solid-like glass doped with absorption centers or a liquid such as a buffer.

Another method of application is to inject coated and non-coated particulates heterogeneous in size having a defined absorption coefficient such as carbon particles into the constricted path. A shock wave is generated using the light source with sufficient energy density and temporal duration to accelerate agent-coated particulates into the surrounding cells. The non-coated particles having larger sizes are used to facilitate the creation of shock waves due to rapid thermal expansion created by absorption of light energy from the laser beam. The particle-liquid-air interface will provide a means of generating tensile stress within the particles as to generate shock waves. The shock wave produces an explosion that accelerates small agent coated particles into the cells as it propagates outward to the surrounding tissues.

A shock wave is generated using the light energy delivered to the absorbing element. Ablation of a small amount of the absorbing element may occur, which facilitates the creation of a tensile stress that adds to the compression stress. The spallation of the ejected mass creates a shock wave that propagates in a radial direction. The shock wave accelerates the particulates that are synchronously delivered to constricted path. Another means is to coat the inner wall of the cylindrical cavity with coated particulates. The shock wave is produced which subsequently transfers its energy to accelerate the particles off the wall and into the constricted path.

A light absorptive liquid is flowed through the conduit around the optical fiber so that it is discharged in constricted path. Laser energy flowing through the optical fiber emerges from the terminal end of the fiber into the light absorptive liquid and creates a rapid displacement of the flowing liquid thereby producing a hydraulic or pressure wave which drives the active agent into the selected site. The distal end of the catheter is positioned according to the pressure stress that needs to be created. Characteristics of the transmitted laser energy which have been found to alter the effectiveness of the encapsulation or extraction of the material from cells are the strength of the targeted cell and physio-chemical properties of the surrounding material, the laser energy, the absorption coefficient of the target cell, the cross-sectional area of the laser energy transmissive means and the number of laser energy pulses used.

The pulsed laser energy creates at least two types of vapor bubbles in the liquid. One type of vapor bubbles is created by the decomposition of organic materials in the ambient body liquid into carbon dioxide and complex organic gases. In addition, the pulsed laser energy creates bubbles, which result from the heating of water contained in the ambient liquid. The pulse of energy creates both of these types of bubbles very rapidly. Bubble creation produces at least two effects. Initially, a pressure wave is created which precedes bubble expansion and then a hydraulic wave is created by fluid displacement from the rapidly expanding bubble. It is theorized that, the expanding bubble, produces an increased fluid pressure along the expanding pressure front and an expanding hydraulic wave caused directly by the expanding surface of bubble. For example, laser energy absorption by blood can produce rapidly expanding vapor bubbles and high-pressure transients of between 10 and 1200 atmospheres. A rapidly expanding vapor bubble can also displace local fluid containing the drug outward into the constricted path without producing significant systemic concentrations.

The light transmissive liquid is injectable, transparent in laser wavelengths, and has a refractive index greater than the refractive index of sidewall. Suitable liquids include solutions of sugars such as mannitol, glucose, dextrose, and iodinated contrast media. A conduit that is 110 cm long, has an interior sidewall of FEP Teflon and contains a sugar solution can transmit about 60% of the laser energy at 480 nm to the distal end, which is launched through a refractive index-matched lens or window into the proximal end from a laser. Multiple laser beams at multiple locations in the constricted path can be sequentially triggered for directing the pressure wave and thereby material into the cell. This can be used in combination with other methods for creating the required pressure. Appropriate combinations of pumps and valves can be used in combination to optimize the pressure gradient.

In one of the embodiments of this invention the laser light is used to create a pressure wave inside the cell. Most of the prior art concentrates on increasing the delivery of material into the cell and is incapable of modifying the rate of encapsulation in the internal structures of the cell including the nucleus. During any of the stressing mechanisms small pores are created in the cell wall. If the light absorbing material is inside the cell or in its immediate vicinity, a huge pressure wave can be created or transmitted inside the cell when the laser light is shined. As the holes are of very small dimensions, wavelength of light, intensity of laser and timing of the laser pulse need to be carefully co-coordinated.

Kovacs et al in U.S. Pat. No. 5,981,268 elaborate that the membrane potential, the voltage difference across a cell's plasma membrane, depends on the distribution of ionic charge. Generally, the distribution of ionic charge determines the electric potential, or voltage. For example, in a metallic conductor, the mobile particles carrying charge are electrons; in an aqueous solution, the mobile particles are ions such as Na⁺, K⁺, Cl⁻, and Ca⁺⁺. In an aqueous solution, the number of positive and negative charges is normally balanced exactly, so that the net charge per unit volume is zero.

An unbalanced excess of positive charges creates a region of high electrical potential, repelling other positive charges and attracting negative charges. An excess of negative charges repels other negative charges and attracts positive charge. When an accumulation of positive charges on one side of a membrane is balanced by an equal and opposite accumulation of negative charges on the other side of the membrane, a difference of electrical potential is set up between the two sides of the membrane. Charge is carried back and forth across the cell membrane by small inorganic ions—chiefly Na⁺, K⁺, Cl⁻, and Ca⁺² but these can traverse the lipid bilayer only by passing through special ion channels. When the ion channels open, the charge distribution shifts and the membrane potential changes. Of these ion channels, those whose permeability is regulated are the most significant; these are referred to as gated channels. Two classes of gated channels are of crucial importance: (1) voltage-gated channels, especially voltage-gated Na⁺ channels, which play the key role in the rapid changes in electrical energy by which an action potential is propagated along a nerve cell process; and (2) ligand-gated channels, which convert extra cellular chemical signals into electrical signals, which play a central role in the operation of synapses. These two types of channels are not peculiar to neurons: they are also found in many other types of cells. By controlling the charge layers around the cell one can control the gated channels thereby enhance the encapsulation or extraction of the material from cells.

Diagnostics:

Many of the single cell based instruments can measure the exact onset of electroporation. Electroporation measurements under selected physiochemical environment can lead to additional information on cells. Kovacs et al in U.S. Pat. No. 5,981,268 elaborate that the membrane capacitance, membrane conductance, cell/substrate separation and action potential parameters of a cell are significant markers regarding a cell's metabolic state, including general cellular health and ionic channel activity. The membrane potential, the voltage difference across a cell's plasma membrane, depends on the distribution of ionic charge.

Generally, the distribution of ionic charge determines the electric potential, or voltage. Groves in U.S. Pat. No. 4,525,666 notes that while the measured size of the cells did not vary appreciably, the breakdown field varied by 65% in response to the older cells' lack of ability to deform, which is a feature well documented in the scientific literature. If the analysis is taken a step further, the internal conductivity of the particle can be determined from the measured opacity and calculated shape factor.

The transmembrane breakdown voltage correlates well with the metabolic state of the cell. The present invention thus provides an apparatus and method for monitoring the impact of an analyte upon the metabolism of a cell. It is to be appreciated that such analytes include pharmaceutical agents, drugs, environmental factors, toxins, chemical agents, biological agents, viruses, and cellular adhesion promoters. Thus, the present invention is useful in screening and assaying broad classes of materials for their impact on cellular metabolism. The present invention provides an apparatus for determining cell membrane dielectric breakdown under different physiochemical environment and thereby is capable of performing a reliable, fast, inexpensive, in vitro quantification of lymphocyte tumor-cell cytotoxicity, lymphocyte membrane fluidity and the establishment of the presence of abnormal or tumor cells.

Essentially the test procedure of this invention involves quantifying the breakdown voltage required to electrically collapse the cell membrane under different temperature conditions, conductivity values, pH values, different material concentration and other parameters. Measuring the cell response in terms of dielectric breakdown, or by the amount or type of material encapsulated or extracted from cells one can obtain crucial information about cells. In the case of the lymphocyte, the voltage at which its membrane undergoes dielectric breakdown (the breakdown voltage) is directly correlated to cytotoxic function, as is well known in prior art.

Lawrence et al in U.S. Pat. No. 5,907,240 describe a method by which the structures of certain cell membranes are selectively altered by employing select membrane-modifying agents, such as lysing agents, detergents or other surfactants, in order to enhance the structural differences of the different cell types (by, for example, increasing the permeability of select cell membranes and/or reducing the structural or “membrane integrity” of select membranes). Clearly combining this with the present invention can lead to significant benefits.

Cell Structure:

Biological cells have an outer, semi permeable plasma membrane that allows the cell to control its internal environment by its selective permeability. The proper function of this membrane is crucial to the viability of the cell. If the function of this membrane is altered or destroyed, cell death often follows. Plasma membranes are typically lipid bilayers, which behave electrically as dielectrics, i.e., they behave as electrical insulators. For eukaryotic cells the cell nucleus and accompanying nuclear membrane reside within the outer membrane, with cytoplasm filling the gap between the nuclear and outer membranes. For prokaryotic cells, there is no nucleus or nuclear membrane, so the cytoplasm, which supports the cell's genetic information (one or more DNA molecules in the form of nucleoids) fills the entire intracellular volume.

Cytoplasm, which refers collectively to the substance filling the gap between the outer and nuclear membrane for eukaryotic cells, or the entire intracellular volume for prokaryotic cells, is mainly composed of cytosol, which is a semi fluid concentrate having an electrical resistivity that is similar to that of aqueous solutions having a standard physiological ionic strength. As such, the cytosol is electrically conductive, which dictates that the intracellular volume of both eukaryotic and prokaryotic cells is electrically conductive. Thus, biological cells can be viewed as a conducting intracellular region surrounded by a dielectric (insulating) membrane.

With this conceptual view of biological cells, application of an external electric field causes charge separation to occur inside the biological cell resulting in a nearly constant intracellular potential that has a value corresponding to the boundary average of the potential established on the outer surface of the cell's dielectric membrane. If the poles of the cell are defined as the two points formed on the surface of the cell by the intersection of a ray parallel to the electric field direction passing through the center of the cell, then application of an external electric field causes one half of the pole-to-pole potential drop outside of the biological cell to develop across the membrane at each pole of the cell. That is, the externally applied electric field produces a maximum transmembrane potential, Vₘ, at each pole of the cell and the imposed electric field within the cell membrane is directly proportional to cell size and applied electric field strength and inversely proportional to the thickness of the cell membrane.

Since the size of many typical biological cells falls within a range of 1<d<50 microns and a typical thickness of cell membrane lipid bilayer is approximately 5 nm, the electric field strength imparted to the membrane can be two to three orders of magnitude greater than the strength of the externally applied electric field. More specifically, for a typical lipid bilayer membrane thickness of about 5 nm, a transmembrane potential Vₘ, of approximately one Volt will impart a 2 MV/cm electric field, Em, to the lipid bilayer membrane. So for a 10-micron diameter spherical cell, which, for example, is about the mean size of peripheral blood cells, a 2 kV/cm externally applied electric field E would generate the 2 MV/cm electric field, Em, in the lipid bilayer membrane. Since the dielectric strength of many polymers, in response to electric fields, is in the range 0.1-0.5 MV/cm, it is reasonable to expect that a 2 MV/cm electric field imparted to the membrane of a 10 micron diameter cell by an externally applied 2 kV/cm electric field would produce membrane pores by dielectric breakdown.

Thus, the electric field magnification provided by the electrical behavior of biological cells can lead to the dielectric breakdown of a cell's membrane when the externally applied electric field has sufficient strength, thereby forming irreversible pores in the membrane which lead to cell death. The susceptibility of a given cell to poration by an applied electric field is dependent on the magnitude of the applied electric field, the size of the cells, the thickness of the dielectric membrane, the dielectric strength of the membrane, chemical uniformity of the membrane, the shape of the cells and the orientation of non-spherical cells in the applied electric field. Thus, a difference in one or more of these properties between different cell types can lead to a difference in their characteristic electroporation threshold and can potentially be exploited to effect a selective cell isolation or inactivation using an applied electric field, as described in greater detail to follow.

In addition to rapidly growing cells, another important exception to the general rule of 1 Volt being a critical transmembrane potential for cell poration and inactivation are spores in their quiescent state which have been shown to be much more insensitive to electric fields and appear to be sensitive only during germination and outgrowth when the cortex disappears and the spore coat layers dissolve as the cell swells. This behavior may be due to the quiescent spores having a much thicker effective dielectric membrane thickness due to the presence of the coat layers. Thus for a given critical transmembrane electric field strength, E_{mc}, which is a function of, for example the resistivity and material properties of the dielectric layer, a larger effective membrane thickness would yield a larger V_{mc}, and would thus require a larger critical applied electric field, E_{c}, for cell inactivation.

For external electric fields of a magnitude such that the change in membrane potential is of the order of the resting potential, voltage induced opening of channels in the membrane causes flux of ions through the membrane. This leads to changes in the ion concentration close to the cell membrane, and consequently causes cell stress. The stress could last for a few microseconds to a few milliseconds. If the strength of the electric field is increased such that the voltage across the cell membrane reaches levels on the order of one volt, the membrane permeability increases to such a level that either the cell needs from seconds to hours to recover (reversible breakdown), or cell death may occur. The pores can be of sizes that allow the exchange of macromolecules. If the transmembrane voltages are sufficiently high the pores will not close anymore.

The threshold electric field E_{c} derived from lethality measurements for E. coli in the logarithmic growth phase is shown in Table 3 to be 0.7 kV/cm, while the threshold field for E. coli in the stationary phase is more than 10 times higher, i.e., 8.3 kV/cm.

The effect of electric fields on biological cells is not simply dependent on the magnitude of the applied electric field, but also on its duration. This can be understood by considering a model for the electrical equivalent circuit of the cell, where the cell (in suspension) is modeled by a resistance and capacitance. For a pulse duration, which is long compared to the dielectric relaxation time of the suspension, the capacitive component of the suspension impedance can be neglected. For many cell suspensions and seawater (i.e., aqueous solutions with relatively high ionic strengths) the dielectric relaxation time is on the order of nanoseconds. The cell membrane can be modeled as capacitor, the cytoplasm as a resistor.

The outer membrane contains channels, which are affected by the applied voltage and allow flow of ions through the membrane, representing a leakage current. The voltage-gated channels can be modeled as variable, voltage-dependent resistors.

Typical stem cells also possess a unique morphology that can make them less susceptible to poration by electric fields than their size would suggest. Morphologically, stem cells are typically small in size (6 micron in diameter for hematopoietic stem cells) with a faint halo of cytoplasm between the nuclear sack surrounded by nuclear membrane, and outer (plasma) membrane. The next larger nucleated hematopoietic cells, resting lymphocytes (7-8 micron in diameter), typically have a much larger gap between their nuclear and outer membranes. The arrangement of the stem cell's nuclear and outer membranes being separated by a very small distance can cause the nuclear and outer membrane to become electrically coupled and to charge together as one effective dielectric layer of thickness approximately equal to the sum of the thickness of the nuclear and outer membranes. Provided the electric field pulse length is small compared to the discharge time scale of the nuclear membrane, electric field strengths considerably greater than the value implied by the diameter of the stem cell and the critical transmembrane voltage, V_{mc}, for the outer membrane will be needed to form temporary or irreversible pores in stem cells.

Field Characteristics:

Electric field strength, total exposure time, and pulse duration, for electroporation can be selected to preferentially inactivate biological cells in constricted path on the basis of difference in susceptibility to electric fields. Differences could be due to having one or more or a combination of the following properties with respect to other cells in the suspension: a larger average size; a thinner effective dielectric membrane thickness; a more spherical shape, etc. Of particular importance for many biological samples, especially those having cells with similar shapes, such as roughly spherical, and similar dielectric membrane thickness is selective inactivation of cells based on a difference in characteristic size.

For example, a variety of cells, such as some epithelial cells and cancer cells, can have a layer of mucopolysaccharide coating associated with their plasma membrane which may increase the effective thickness of the membrane and make the cells less susceptible to an applied electric field. Thus, an applied electric field strength may be chosen that is sufficient to inactivate a substantial fraction of cells having an effective membrane thickness below a certain predetermined threshold without inactivating a substantial fraction of the cells having an effective membrane thickness above the threshold.

In some embodiments, where it is desired to alter the apparent membrane breakdown voltage or characteristic size of one or more subpopulations of cells in a heterogeneous population of cells, for example when the electroporation thresholds of desirable and undesirable cellular subsets are comparable, such alterations can be effected by attaching material to cellular subsets using antibodies that have immunospecificity for the cells, especially monoclonal antibodies.

For example, metallic beads coated with a monoclonal antibody that can bind the bead to a specific cell surface antigen can produce two distinctly different effects depending upon the surface density of the beads attached to the cell. If the surface density of the attached beads is very high, such that an almost continuous layer of metallic beads exists on the surface of the cell, then the resulting metallic structure will behave as a Faraday cage, which will shield the cell from the effects of the imposed electric fields. If the surface density of the beads on the cells is low, however, then the each bead will behave as an antenna, which can make the effective size of the cell larger, thereby making the cells more susceptible to the lethal effects of the imposed electric fields than implied by the original size of the cell. Thus, agents, such as antibody coated metallic beads, can be used to alter the electroporation thresholds of specific cells, thereby enhancing PEF selection or inactivation characteristics.

Pulsed Electric Field:

In order to reduce the tendency for the electrical potential applied to the electrodes to discharge by arcing, and in order to reduce the degree of electrical heating that occurs in the cell suspension, in certain preferred embodiments, the applied electric field is pulsed for short durations. Such electric fields are generally referred to as “pulsed electric fields” or PEFs. The shape of the electric field pulse is preferably substantially rectangular in shape, thus providing very short voltage rise and fall times and a substantially constant magnitude over the entire pulse length. Any pulse shape known in the art may be employed in performing the methods of the invention, especially when high resolution is not required, as, for example, when inactivating a cell type that is substantially larger than the desired cell type.

When a voltage pulse is applied to the cell, charges accumulate at the membrane and the membrane voltage is increased. Electric field and energy density versus pulse duration can be plotted. The curves show a minimum at 100 nsec for spherical cells of radius 5 microns (suspension resistivity of 50 OMEGA-cm and cytoplasm resistivity of 100 OMEGA-cm). This is the pulse duration where the stunning or killing of these kind of biological cells is predicted to be most effective. Experimental studies have reported which confirm the presence of such a minimum.

By applying one or more ultrashort electric field pulses to target cells subcellular structures in the target cell can be modified. The amplitude of individual pulses does not exceed the irreversible breakdown field of the target cells. The amplitude and duration of the ultrashort electric field pulse(s) are typically chosen so as to be insufficient to permanently alter permeability of surface membranes of the target cells, e.g., by rupturing the surface membranes. The targeting of substructures of cells rather than cell membranes can have a utility in treatments involving the selective destruction of cells (e.g., tumor cells) without substantially damaging surrounding tissue(s).

Another advantage of using ultrashort pulses is the low energy of these pulses. Although the electrical power of the pulses may be many megawatts, the energy of these pulses is often so low (due to their short duration) that any thermal effects on cells can be neglected and are sometimes referred to as “cold” method, which can allow modification of cells via electrical effects without creating any substantial related thermal effects. The ability to electrically modify cells in a “cold” manner is particularly useful where the intent is to selectively modify subcellular structures within a target cell without substantially affecting the cell membrane. Schoenbach et al in U.S. Pat. No. 6,326,177 describes a pulse generator capable of producing an ultrashort electric pulse output and a delivery system capable of directing the electric pulse output to target cells.

To study the impact of ultra-short pulses on intra-cellular structures, such as the cell nucleus in eukaryotic cells, requires a more complex model of the equivalent circuit. The substructures can be modeled by treating the membrane surrounding the nucleus as a capacitor and the interior of the nucleus as a resistor, both elements in series and in parallel to the resistance which describes the cytoplasm in the first, simplified, equivalent. Similarly, the nucleoli can also be described by an additional capacitor resistor arrangement in parallel to the nucleus resistance. Basic electrical circuit principles indicate that low frequency electric fields will affect mainly the larger capacitance, which is the outer membrane. With increasing frequency, the outer membrane, however, will be effectively shorted out, and the applied voltage will appear across the inner (nucleus) membrane. This model predicts that at frequencies around 1 MHz, the applied voltage should appear mainly across the membrane of the nucleus, rather than across the outer membrane. This means that shorter pulses with higher frequency components would be expected to affect the nucleus of a cell rather than the cell membrane.

Two lipid bilayer membranes that make up the nuclear envelope surround the nucleus. Other intracellular structures (e.g., intracellular granules) may have only one lipid bilayer membrane surrounding them. From this simple theoretical model, a number of insights can be obtained regarding cell behavior when they are stressed by an electric field. The voltage across the intracellular membrane may reach values on the same order as the voltage across the outer membrane if the pulse duration is larger than the charging time of the intracellular membrane and the pulse rise time is small compared to this charging time.

To reach voltages in excess of 1 volt across intracellular membranes, electric field amplitudes in the megavolt/m range are required on a time scale of the charging time of the intracellular membrane. Only if both conditions are satisfied (i.e., large electric field amplitude plus extremely fast rates of change in the electric field), can intracellular effects be expected. The voltage across intracellular membranes is expected to be almost linearly dependent on the diameter of the intracellular structure. Stronger effects at larger internal structures would therefore be expected with the same electrical parameters. Reaching a critical voltage across the intracellular membrane is a necessary but not sufficient condition for “intracellular electromanipulation” (“IEM”). In order to change the structure of the membrane, e.g., open membrane defects to a size that allows passage of macromolecules through them, the critical voltage needs to be applied long enough to allow expansion of the defects to appropriate size. Estimates of the voltage required to achieve such effects at the surface membrane have been reported, but no such estimates exist for intracellular membranes.

Each ultrashort electric field pulses typically has a pulse duration of no more than about 1 microsecond and an amplitude of at least about 20 kV/cm. Characterized in a different fashion, the ultrashort electric field pulses typically have a pulse duration of no more than about 1 microsecond and a total energy from 75 mJ/cc to 10 J/cc. In instances where extremely short pulses are applied, e.g., pulses having duration of about 10 nanoseconds or less, the total energy of the electric field pulse may only be on the order of about 10 to 20 mJ/cc. In addition to having short durations, the electric field pulses used may have rise times of 50 nsec or less. The amplitude of an electric field (the applied voltage divided by distance between electrodes) pulse is generally at least about 20 kV/cm, but should not exceed the breakdown field of the suspension or tissue, which includes the target cells. The breakdown field increases with decreasing pulse duration, and can be experimentally determined. Under the conditions commonly employed, the breakdown field does generally not exceed 500 kV/cm.

To minimize the potential effects on the bulk temperature of the medium (“thermal effects”), the electrical field pulses generally have a rapid rise time and short duration. The pulses should preferably be less than one microsecond, but more than 100 picoseconds in duration. Typical pulse duration is about 1 nanosecond to about 500 nanoseconds, with pulses typically having duration of about 10 to a 300 nanoseconds. The optimum pulse duration will vary depending on the cell type, tissue type and desired treatment, among other factors. The pulse should be preferentially rectangular or trapezoidal, but other pulse shapes may also be used.

For example, in order to open both the outer and inner cell membranes, an intense short pulse might be combined with a less intense longer pulse. Other examples of suitable pulse shapes include exponential decaying pulses, unipolar pulses and bipolar pulses. The rise time of the ultrashort electric field pulse is typically no more than about 20% and, preferably, no more than about 10% of the pulse duration. For example, if the pulse duration is about 100 nanoseconds, the rise time of the pulse is preferably about 10 nanoseconds or shorter. For pulses with pulse durations of about 400 nanoseconds or longer, the pulse rise times of about 30-40 nanoseconds are common. With pulses having extremely short durations, e.g., one nanosecond or less, the rise time is often a greater percentage of the pulse duration. For example, pulses with duration of less than one nanosecond, can commonly have a rise time, which is up to about 50% of the pulse duration. As indicated above, to modify subcellular structures in target cells it may be advantageous to apply a series of ultrashort electric field pulses within a relatively short time interval. For example, it has been found that the application of a sequence of 3 to 5 ultrashort electric field pulses (e.g., trapezoidal pulses with durations of 10-300 nsec and amplitudes of about 25 to 300 kV/cm) may be more effective at modifying intracellular substructures than a single pulse of the same amplitude and duration.

In one embodiment, the present method can be used to modulate cell function, either through enhancing or attenuating the particular cell function depending on the cell type, phase of the cell and intended treatment. For example, target cells can be subjected to an electric field pulse of sufficient amplitude and duration to modify chemotactic activity in the target cells without reversibly disrupting the permeability of surface membranes in the target cells. Under appropriate conditions, e.g., by applying electric field pulses of 60 to 300 nsec duration having total energies of about 150 to 1000 mJ/cc, the chemotactic activity of cells, such as human neutrophils, can be inhibited.

The pulse generator includes a pulse forming network and a high voltage switch. The pulse-forming network may be a high voltage cable, a strip-line, or a pulse-forming network constructed of individual capacitors and inductors in a transmission line arrangement. The high voltage switch can suitably be a gaseous, liquid or solid-state switch. The energy in the pulse-forming network may be stored capacitively, which requires a closing switch to release a pulse, or inductively, which requires an opening switch to release a pulse. Upon triggering of the switch, an electrical pulse is launched into the load, i.e., the target cells in suspension or tissue form. The switch can be triggered by a variety of common methods, e.g., optically or electrically. The latter can b accomplished by employing a third electrode or by overvolting the switch.

Rise in Temperature:

One important consideration in designing and implementing a PEF isolation or inactivation strategy is heat effects and temperature rise due to heat generated within the PEF treatment cell due to the energy deposited in constricted path by the electric field. One issue that depends heavily on heat transfer effects is whether the total exposure time of the treated suspension should be achieved with a single pulse or with a series of pulses. Since many biological cells can be non-selectively inactivated by overheating, which is not a function of electroporation threshold, and since a single long electric field pulse can, without sufficient heat removal, cause a greater amount of heating of the cells for a given total exposure time, it is preferable, for many embodiments, to apply the total electric field exposure time as a series of pulses, rather than as a single pulse of longer duration. Since cyclic heating and cooling is particularly destructive for blood cells, pulse duration should be kept short enough to minimize cell and cell suspension temperature excursions beyond the physiological range.

The rate, or frequency, at which electric field pulses may be applied is related to the energy deposited in the pulsing medium per electric field pulse (Joule heating), the geometric shape and heat transfer characteristics of the constricted path and the density and thermal conductivity of the pulsing medium (which collectively dictate heat removal rates), and the heat capacity of the pulsing medium. There are two components to the total temperature rise in the PEF treatment volume as a function of the electrical energy input: the temperature jump ΔTⱼ (° C.) that occurs for each individual electrical pulse; and the steady pulsing temperature rise ΔTₛ (° C.) which is a function of the volume and heat transfer characteristics of the constricted path. Each time a pulse is applied to the pulsing medium, the temperature will jump.

The magnitude of the temperature jump is proportional to the power density Wp that is dependent on the electric field pulse length, electric field strength, density of the pulsing medium, resistivity of the pulsing suspension and specific heat of the pulsing medium. For typical values the rise in temperature can be easily restricted to a few ° C. The steady temperature rise is a function of the heat input per pulse, the number of pulses per unit time (frequency), and the heat transfer rate of the constricted path tending to remove heat from the treatment volume.

Shape and Orientation:

Another previously mentioned factor that can influence the way in which an applied electric field interacts with a cell suspension, and the selectivity of an applied electric field at inactivating cells based on a critical electroporation threshold, is the shape and orientation of cells within the field. This factor is important for any cell inactivation involving nonspherical shaped cells. A problem arises with such samples because non-spherical cells, in a given sample, are typically randomly aligned with respect to the electric field direction. While such a random alignment is not a problem for hematopoietic stem cells or other essentially spherical cells, random orientation can reduce the effectiveness, especially for cells with large aspect ratios, of cell inactivation with applied electric fields. Transmembrane voltage is directly proportional to the projected length, of the cell in the electric field direction.

Thus, for cells with large aspect ratios, length can be highly variable depending on the orientation of the cell. Since it is typically desirable to apply an essentially time-invariant transmembrane voltage for a predetermined length of time in order to obtain more easily predictable and controllable poration results, it is therefore desirable to align cells that are not substantially spherical so that they have a more consistent and predictable orientation with respect to the electric field direction. For embodiments of the invention where it is desired to align the axes of cylindrical or oval shaped cells an AC field can be applied across the sample to accomplish this function.

The AC field is preferably selected to provide an essentially uniform oscillating electric field during the PEF treatment period, and has a magnitude selected to be sufficient to align the cells with their long dimensions parallel to the PEF field direction for optimum size selectivity by the PEF field, without porating the cells or unduly overheating the pulsing medium. The theoretical treatment of this cell alignment technique is discussed in detail by Lynch (Lynch P T and Davey M R. Electrical Manipulation of Cells, Chapman and Hall, New York, Chapter 4, 1996), herein incorporated by reference.

Some preferred embodiments of the invention include the use of an applied electric field for cell inactivation that is a bipolar electric field. A “bipolar electric field” as used herein refers to an electric field that is pulsed or otherwise applied to a sample so that the average current across the sample over the total treatment time is essentially zero. The use of bipolar electric fields in the context of the present invention provides several advantages over non-bipolar fields.

When an electric field is applied across a sample, particularly a blood sample, electrochemical reactions can occur which can produce free radicals, other deleterious compounds, and species that can shift suspension pH and/or generate bubbles. Such electrochemical effects are, as previously indicated, undesirable. Electrochemical effects can be reduced or eliminated by utilizing a bipolar electric field pulsed so that the average current across the sample over the treatment time is essentially zero. Because the application of the bipolar electric field involves essentially equal current flows across the sample for each applied polarity, the reversible electrochemical reactions induced by the applied electric field component having a first polarity, can be substantially reversed by the applied electric field component having the opposite polarity, thus yielding a situation characterized by no net electrochemical reaction over the treatment time.

There are a variety of ways to apply a bipolar electric field to the sample as apparent to one skilled in the electrical engineering arts. For some embodiments, the pulses across the sample are of essentially equal magnitude, duration, and number, but alternate pulses are of opposite polarity, while for other embodiments, the pulse having a first polarity may be of greater magnitude but shorter duration while the pulse of the reverse polarity is of lower magnitude and longer duration, so that the total average current flow is essentially zero. In another embodiment, an electric field pulse having a first polarity is utilized together with a DC current having an opposite polarity selected so that the magnitude and duration of each is selected to yield an essentially zero net current in order to achieve no net electrochemical reaction within the sample.

In yet another embodiment for creating a desired bipolar electric field, the pulse used to create the PEF field may also be utilized to charge a suitable capacitor. When the original PEF pulse terminates, the capacitor then discharges back through the solution containing the cells at a rate determined in part by a resistance in the discharge path to produce the desired bipolar field.

In addition to reducing undesired electrochemical reactions, bipolar PEFs can provide an additional advantage in the selective inactivation/lysing of larger cells. The additional advantage lies in that the first pulse component having a first polarity results in a charge across the membrane of the cell, which remains for some period of time after the first pulse component, terminates. If a second pulse component having an opposite polarity is applied across the cell during this time, the voltage across the cell can be effectively doubled for a short period of time. This doubling effect is greater for larger cells than for smaller cells because of the larger membrane charging time scale for larger cells. This effect can potentially enhance size-selective destruction of the larger cells, thereby enhancing the cell selectivity of the invention for certain applications.

Constricted Path:

The configuration of the constricted path is not critical to the invention, and can vary widely in shape and size while still serving the purposes and advantages of the invention.

Flow-through chambers offer the advantage of permitting the successive entry and removal of individual cells so that large numbers of cells can be treated in succession. Flow-through chambers also permit replenishment of solute-depleted solutions so that concentration gradients can be continuously maintained when desired. A further function that can be served by flow-through chambers is the increase and decrease of pressure. For flow based apparatus the flow-through chambers should be so constructed so as to allow the passage of the liquids in continuous flow, intermittent flow, or flow at the direction of the user, and to allow changes in the concentrations, pressure, and other conditions as needed to achieve close control over the passage of species across the biological cell membrane.

The chamber can be made of any type of insulating material, including, but not limited to, ceramic, Teflon, Plexiglas, glass, plastic, silicon, rubber or other synthetic materials. Preferably, the chamber is comprised of glass or polysulfone. Whatever the composition of the chamber, the internal surface of the chamber should be smooth to reduce turbulence in the fluid passing through it. The housing of the chamber should be nonconductive and biologically inert. In commercial use, it is anticipated that the chamber will be disposable.

In one preferred embodiment of the present invention, the electrodes that comprise part of the apparatus and their respective interconnects and bond pads can be constructed from any type of electrically or thermally conductive hollow or solid material, including, but not limited to, brass, stainless steel, gold plated stainless steel, gold plated glass, gold plated plastic, or metal containing plastic, silver, tungsten, iridium, activated iridium, gold, platinum, polysilicon, aluminum, ITO, or TiW, bare or electroplated with platinum black.

Preferably, the surface of the electrode is gold plated. Coating with Platinum black increases the effective surface area for microelectrodes. Gold plating serves to eliminate oxidation and reduces the collection of hemoglobin and other cell particles at the electrodes. The surface of the electrodes should be smooth.

Additionally, the substrate of the integrated device may comprise a variety of materials, such as silicon, glass, metal, quartz, plastic, ceramic, polyethylene, or any other suitable type of polymer. It is noted that glass substrates have been found to provide reduced parasitic capacitance. Substrates may utilize different passivation layers ranging from 1 to 5 microns in thickness. The passivation layer may comprise any suitable material, including low stress PECVD silicon nitride, silicon carbide, TEFLON, polyimide, ceramic, photoresist, or any type of polymer or thermal plastic, or combination thereof.

The bondwires are encapsulated (for mechanical and electrical robustness) in a nontoxic low stress epoxy. Bondwire encapsulation may also be achieved with polyurethane, polyethylene, wax, silicon carbide, silicon nitride, TEFLON, or polyimide.

The electrodes can be hollow; to allow cooling by liquid or gas, or the electrodes can be solid, to allow for thermoelectric or any other type of conductive cooling. Cooling could also be accomplished by cooling the chamber itself, apart from cooling the electrodes. Preferably, the flow electroporation chamber is disposable.

Signal generating circuitry 51 establishes the required electromagnetic field in the constricted volume and feeds electromagnetic radiation in the constricted volume. Signal analysis circuitry 53 is responsive to change in electromagnetic field and electromagnetic radiation due to the passage of particle in the constricted volume. Signal generating circuitry 51 in response to the measurements activates the cell stressing means depending on the cell size, orientation, membrane integrity, membrane surface mmarkers and intracellular complexity, of the respective cell. Electroporation field can be created in multiple ways including as a continuous field, pulse field, can be triggered only when the cells are present or as a bipolar field. Separate electrodes can establish the measurement field and electroporation field.

In one of the embodiments the cell separation means are connected down the line (not shown). Most of the standard flow cytometers have a piezo valve in the flow chamber and an electronic device for the piezoelectric activation. The piezo deflects the cells of interest in a second branch of the flow cell for separating the cells.

Optical Waveguides:

In the preferred embodiment, light scatter is measured within four different angular ranges, i.e., (a) between about 10 degrees and about 70 degrees, referred to as medium angle light scatters or MALS; (b) between about 10 degrees and about 20 degrees, referred to as lower medium angle light scatter or LMALS; (c) between about 20 degrees and about 70 degrees, referred to as upper medium angle light scatter or UMALS; and (d) between about 80 degrees and about 100 degrees, nominally orthogonal, referred to as side-scatter or SS. Similarly, the fluorescence of a cell is preferably measured within discrete, multiple wavelength ranges, F1, F2, and F3, such ranges being determined by the respective fluorescence emission spectra of the dyes and fluorochromes used to label the cells of interest.

Multiple measurements are made on each cell or platelet simultaneously, namely, Volume and Conductivity, plus four light scatter and three fluorescence measurements and in some cases even image analysis is performed. Obviously, the number of light scatter measurements can be increased to as many as desired, and the number of fluorescence measurements can be increased (within reason) by increasing the number of photodetectors to correspond to the number of fluorescence spectra emitted by the dye(s) and fluorochrome(s) used to label cells of interest. A discussion of the V, C and S parameters, as well as various other parameters referred to herein, for example, rotated light scatter (RLS) and opacity (RF/DC or C/V), can be found as per U.S. Pat. No. 5,125,737 issued to C. Rodriguez and W. Coulter, the subject matter of which is hereby incorporated herein by reference.

The respective transducer outputs, V, C, S and F, are fed to a signals analysis circuitry which, based on programmed algorithms, operates to differentiate and enumerate the different cell types and subsets in the sample, as well as to determine various blood and cell parameters, e.g., Hgb, Hct, MCV, etc., and to provide a report. Because the multi-parametric transducer measures all four cell parameters simultaneously, and because precisely metered volumes of sample are passed through the transducer, there is no need to correlate the respective outputs of multiple transducers, as is required by all conventional cell analysis systems, and the accuracy of the analyzer is thus further enhanced. Also, by measuring all four parameters simultaneously on a single cell, a four-parameter multidimensional analysis of each cell is made possible, thereby enabling a more accurate (unambiguous) determination of cell type to be made.

The central component of the cell analyzer briefly described above is integrating the optical waveguides in the circumference of the orifice. As each cell passes through the constricted volume, it is irradiated with a focused laser beam, as provided by a suitable continuous-wave laser, and radiation (light) scattered from each cell is detected by a pair of light scatter detectors LSD1 and LSD2. At the same time, fluorescent radiation, if any, emitted by a cell's fluorescent stain or fluorescent label as a result of being excited by the laser radiation, is detected by a florescence-detector FD.

The transducer can be integrated with an optical element of a square prism shape, comprising four rectangular, optically flat sides. Optical element can be fabricated from fused silica, or quartz. The advantage of integrating with a optical element is that optodes can be used simultaneously with the prior art techniques. A plano-convex lens can be suitably attached (e.g., by optical cement) to one of the flat sides of the optical element, such lens functioning to optically couple fluorescent radiation out of the interrogation zone and onto the fluorescence-detecting photo detector package.

The end of the optode facing the orifice needs to be flat to ensure proper transmission of the light to the orifice. Waveguides dimension can be from less than a micron to a few tens of microns.

It further includes a laser or the like for producing a beam of radiation having a wavelength adapted to excite a fluorescent material carried by selected cells of interest, and a lens for focusing the laser beam into the constricted volume. Suitable laser sources are a continuous-wave argon laser, which emits at 488 nm., and a diode-pumped solid-state laser emitting at 532 nm. Radiation scattered by an irradiated cell, within the constricted volume is detected by the two light scatter detector units LSD1 and LSD2. LSD1 is located to detect light scattered in a direction substantially normal (i.e., at about 90.degree . . . +−.about 10 degree) with respect to the axis of beam, and LSD2 is located and structured to detect light scattered in a forward plane within an angular range of between about 20 degrees and 70 degrees (MALS). LSD1 preferably comprises a focusing lens which operates to focus sidescattered light onto a pin diode or the like. The MALS light scatter detector LSD2, has two photoactive regions, an upper median angle light scatter (UMALS) region, and a lower median angle light scatter (LMALS) region. As noted above, the UMALS region is adapted to detect light scattered in the angular range of between 20 and 70 degrees, and the LMALS region is adapted to detect light scattered within the angular range of between 10 and 20 degrees.

Precaution must be taken to prevent unscattered laser light, as well as light scattered at less than 10 degrees, from striking the LMALS region. Precaution must also be taken to prevent any scattered or diffracted light in the vicinity of the horizontal plane from striking either the UMALS or the LMALS regions. LSD2 produces individual, MALS, UMALS and LMALS pulse signals that are output to the signal analysis circuitry through suitable preamplifiers.

Fluorescent radiation emitted by irradiated cells in the constricted volume is collected by the aforementioned lens affixed to the optical element, collimated and spacially filtered by a lens assembly and relayed to a plurality of photomultiplier tubes PMT through a network of beam-splitting dichroic mirrors, and filters.

In a conventional manner, each photomultiplier tube detects fluorescent radiation in a wavelength range determined by the optical coatings on the dichroic mirrors and filters. The respective outputs of the photomultiplier tubes are suitably amplified and fed to the analyzer signal analysis circuitry.

FIG. 15 illustrates an optode which utilizes an optical waveguide and placed next to the orifice. Najafi et al in U.S. Pat. No. 5,080,503 describe an optical waveguide device and a method for making optical waveguides in a substrate. The apparatus comprises a substrate; a waveguide embedded in the substrate, the waveguide having a refractive index higher than the refractive index of the substrate; and first and second optical mirrors (not shown) placed respectively in two different positions along the waveguide. The method comprises steps of (a) cleaning a substrate by means of a cleaning agent; (b) embedding a waveguide in the substrate; and (c) placing first and second optical mirrors respectively at two different positions in the substrate, the steps (b) and (c) being performed in such a manner that the mirrors being positioned along the waveguide. Optode can be fabricated in multiple way as is well known in the art. In one of the embodiments optical fibres can be used as optodes.

FIG. 16 shows an example of a conventional waveguide type optical integrated circuit element. The waveguide type optical integrated circuit element includes a semiconductor laser 200 and optical waveguide 210.

The semiconductor laser and the optical waveguide are formed integrally on a same substrate 201. One example of the method for realizing this integration is an abutting method for the formation of the laser. Substrate is vertically etched to remove part thereof, and an optical waveguide structure is formed in the etched area. The optical waveguide structure includes an optical waveguide 210 layer, optical confinement layers and 208 sandwiching the optical waveguide layer 206, a buffer layer 202, and a capping layer 209 located on the outer sides of the optical confinement layers 204 and 208, respectively. The semiconductor laser 200 includes a first cladding layer, an active layer, a carrier barrier layer, a first guiding layer, a second guiding layer, and a second cladding layer as is well known in the art. Light emitted from the semiconductor laser 200 is directly coupled with the optical waveguide structure 210, and propagates in the optical waveguide layer 206.

The abutting method described above eliminates the necessity of positioning the semiconductor laser and the optical waveguide with each other, thereby providing high mechanical stability, compared with a method where they are separately fabricated and then bonded together. Precaution must be taken to reduce the losses at the interface. The vertical beam diameter of light emitted from the semiconductor laser should match with the vertical beam diameter in a native mode of the optical waveguide structure 210.

One of the methods for fabricating the waveguides is illustrated here. A GaAs substrate (wafer) is placed in an MOCVD apparatus, and semiconductor layers constituting an AlGaAs semiconductor laser can be grown on the GaAs substrate by MOCVD. The semiconductor laser in this example is of a general double-hetero (DH) structure having a vertical beam diameter of about 1 micron. The semiconductor layers constituting the semiconductor laser include a first cladding layer, an active layer, a second cladding layer, and a contact layer. The active layer was grown to have an Al mole fraction of 0.14 and realize an desired oscillation wavelength. The resultant wafer with the above semiconductor layers formed thereon is taken out from the MOCVD apparatus, and partly etched vertically to a depth reaching the GaAs substrate by reactive ion beam etching (RIBE) using chlorine gas. The wafer is returned to the MOCVD apparatus, semiconductor layers constituting an optical waveguide is grown by MOCVD. The semiconductor layers include an optical waveguide layer, optical confinement layers and sandwiching the optical waveguide layer, and buffer layers. The optical waveguide layer has an Al mole fraction of 0.2 and a thickness of 2 microns. The optical confinement layers have an Al mole fraction of 0.22 and a thickness of 1 micron. The optical waveguide can be made transparent to output light of the semiconductor laser and serves as a low-loss waveguide. The interface area between the semiconductor laser and the optical waveguide is vertically etched over a width of 2 microns. The etching depth is not required to be precisely controlled and can be done using RIBE. The only requirement is that the etching should penetrate through the entire optical waveguide. Subsequently, an AlGaAs buried region 40 having an Al mole fraction of 0.2 is grown in the etched area by MOCVD. Finally, the portion of the semiconductor layers for the optical waveguide and the portion of the semiconductor layer for the buried layer grown on the semiconductor laser are removed. The resultant structure is processed into a ridge shape, to realize transverse light confinement. Subsequent steps such as electrode formation and cleaving are then performed, to obtain the waveguide type optical integrated circuit element of this example. The resultant waveguide type optical integrated circuit element of this example is substantially free from the slant layer structure and thus no great coupling loss due to radiation loss occurs.

Reichert et al in U.S. Pat. No. 6,350,413 describe a step-gradient composite waveguide for evanescent sensing in fluorescent binding assays comprises a thick substrate layer having one or more thin film waveguide channels deposited thereon. The substrate can be silicon dioxide and the thin film can be silicon oxynitride. It also illustrates the light input coupling means integrally adapted to the thin film channels. Such light coupling means can be a grating etched into the substrate prior to deposition of the thin film, or a waveguide coupler affixed to the upper surface of the thin film. The waveguide coupler has a thick input waveguide of high refractive index which receives the laser light through one end and propagates it by total internal reflection. The propagated light is then coupled evanescently into the thin film waveguide across a spacer layer of precise thickness and having an index of refraction lower than either the input waveguide or the thin-film waveguide. The composite waveguide can be constructed by plasma vapor deposition of silicon oxynitride onto the silicon dioxide substrate, masking the channel waveguides with a photoresist, and using reactive ion etching to expose the substrate in the unmasked regions.

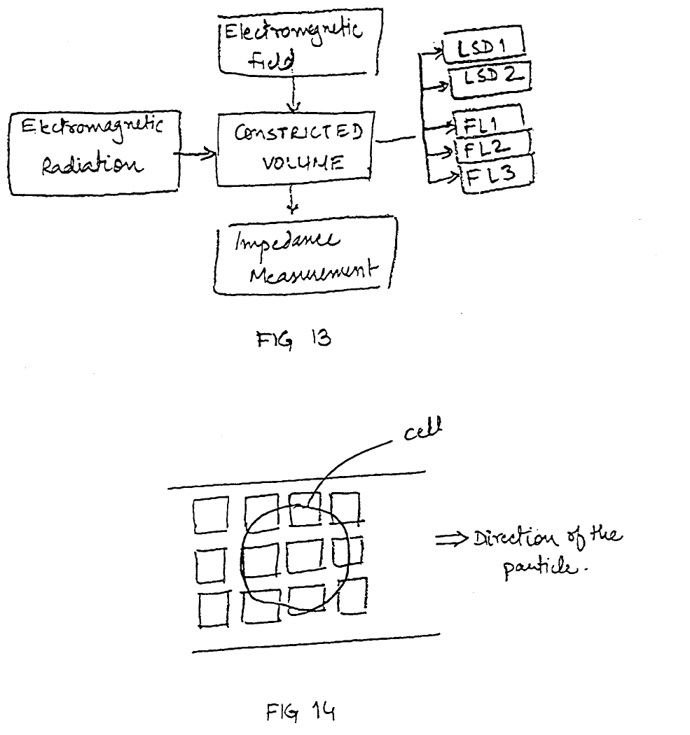

In one embodiment of the invention optodes can be used for getting a direct projection of the particle as illustrated by Nieuwenhuis et al. When a particle moves over the photodiode structures it will partially block the light and its projection is registered. In this way a two-dimensional projection of the particle can be obtained from which shape information can be extracted. Using hydrodynamic focusing it is necessary to ensure that the particles are close to the photo-diode array otherwise diffracted signals are obtained. FIG. 14 illustrates an optrode array for getting the projected image of the cell.

Thus, each particle that passes through the flow cell can be mapped into a feature space whose axes are the emission colors, light intensities, or other properties, i.e. scatter, measured by the detectors. Preferably, the different particles in the sample can be mapped into distinct and non-overlapping regions of the feature space, allowing each particle to be analyzed based on its mapping in the feature space. Optical measurements are not restricted to what has been illustrated and include far field measurements, near field measurements, scatter measurements, light obstruction measurements, interference measurements, photon correlation spectroscopy and others.

By correlating information from microelectrodes and optodes information can be obtained regarding the intra-cellular components. The advantage of the design is that optodes and microelectrodes can be placed very close to each other thereby allowing very high level of correlation between the signals.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. An apparatus for measuring and manipulating particles suspended in a fluid having electromagnetic and optical properties different from that of the particles, as the fluid and particles move in a constricted volume along its longitudinal axis, and further comprising means for establishing and sensing an electromagnetic field in the constricted volume and means for making the fluid that is carrying the particles flow through the orifice.
